(19) United States
(12) Patent Application Publication
(10) Pub. No.: US 2024/0354108 A1
(43) Pub. Date: Oct. 24, 2024

(54) MEMORY SAFETY USING TAG CHECKING INSTRUCTIONS AND ISLANDS OF TAGS IN LINE WITH BUCKETED DATA

(71) Applicant: Intel Corporation, Santa Clara, CA (US)

(72) Inventors: Michael LeMay, Hillsboro, OR (US); David M. Durham, Beaverton, OR (US); Joseph Cihula, Hillsboro, OR (US); Joseph Nuzman, Haifa (IL); Dan Baum, Haifa (IL); Jonathan Combs, Austin, TX (US)

(73) Assignee: Intel Corporation, Santa Clara, CA (US)

(21) Appl. No.: 18/478,882

(22) Filed: Sep. 29, 2023

Related U.S. Application Data
(60) Provisional application No. 63/497,174, filed on Apr. 19, 2023.

(51) Int. Cl. G06F 9/30

(52) U.S. Cl. CPC G06F 9/3016

(57) ABSTRACT

Techniques for implementing instructions and modified instruction encodings for checking tags and for interspersing islands of tags in line with bucketed data for locality by a processor are described. In an example, an apparatus includes decoder circuitry and execution circuitry. The decoder circuitry is to decode an instruction into a decoded instruction. The instruction has an opcode to indicate that the execution circuitry is to use metadata and instruction encodings to selectively perform a memory safety check. The execution circuitry is to execute the decoded instruction according to the opcode.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, and exception handling, and external input and output (IO). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF DRAWINGS

Various examples in accordance with the present disclosure will be described with reference to the drawings, in which:

FIG. 1 illustrates metadata (e.g., tags) positioned relative to data in a page according to examples of the disclosure.

FIG. 2 illustrates even and odd slot polarity for a page according to examples of the disclosure.

FIG. 3 illustrates an example pointer format comprising a field for an expected polarity for an object to be accessed according to examples of the disclosure.

FIG. 4 illustrates a block diagram comprising an enhanced compiler to instrument code with explicit instructions to check accesses according to examples of the disclosure.

FIG. 5 is a flow diagram illustrating operations of a method for performing a check tag (CkhTag) operation according to examples of the disclosure.

FIG. 6 is a flow diagram illustrating further operations of a method for performing a check tag (CkhTag) operation according to examples of the disclosure.

FIG. 7 illustrates accelerating metadata (e.g., tag) checks using a translation lookaside buffer (TLB) and an object lookaside buffer (OLB) according to examples of the disclosure.

FIG. 8 illustrates caching metadata in memory sidecars based on physical metadata indexing according to examples of the disclosure.

FIG. 9 illustrates bucketing smaller objects into a tier with inline clustered metadata (e.g., tags) and larger objects into a different tier without inline clustered metadata (e.g., tags) according to examples of the disclosure.

FIG. 10 illustrates multiple types of metadata (e.g., tags) positioned relative to data in a page according to examples of the disclosure.

FIG. 11 illustrates an example computing system.

FIG. 12 illustrates a block diagram of an example processor and/or System on a Chip (SoC) that may have one or more cores and an integrated memory controller.

FIG. 13A is a block diagram illustrating both an example in-order pipeline and an example register renaming, out-of-order issue/execution pipeline according to examples.

FIG. 13B is a block diagram illustrating both an example in-order architecture core and an example register renaming, out-of-order issue/execution architecture core to be included in a processor according to examples.

FIG. 14 illustrates examples of execution unit(s) circuitry.

FIG. 15 is a block diagram of a register architecture according to some examples.

FIG. 16 illustrates examples of an instruction format.

FIG. 17 illustrates examples of an addressing information field.

FIG. 18 illustrates examples of a first prefix.

FIGS. 19A-19D illustrate examples of how the R, X, and B fields of the first prefix in FIG. 18 are used.

FIGS. 20A and 20B illustrate examples of a second prefix.

FIG. 21 illustrates examples of a third prefix.

FIG. 22 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for interspersing islands of tags in line with bucketed data for locality.

In the following description, numerous specific details are set forth. However, it is understood that examples of the disclosure may be practiced without these specific details. In other instances, well-known circuits, structures, and techniques have not been shown in detail in order not to obscure the understanding of this description.

References in the specification to “one example,” “an example,” “examples,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. Certain operations include accessing one or more memory locations, e.g., to store and/or read (e.g., load) data.

For convenience and/or examples, some features (e.g., instructions, etc.) may be referred to by a name associated with a specific processor architecture (e.g., Intel® 64 and/or IA32), but embodiments are not limited to those features, names, architectures, etc.

A system may include a plurality of cores, e.g., with a proper subset of cores in each socket of a plurality of sockets, e.g., of a system-on-a-chip (SoC). Each core (e.g., each processor or each socket) may access data storage (e.g., a memory). Memory may include volatile memory (e.g., dynamic random-access memory (DRAM)) or (e.g., byte-addressable) persistent (e.g., non-volatile) memory (e.g., non-volatile RAM) (e.g., separate from any system storage, such as, but not limited, separate from a hard disk drive). One example of persistent memory is a dual in-line memory module (DIMM) (e.g., a non-volatile DIMM), for example, accessible according to a Peripheral Component Interconnect Express (PCIe) standard.

Memory unsafety accounts for numerous parts (e.g., about 70%) of software vulnerabilities reported, so there is a pressing need for efficient mitigations. Examples herein are directed to a memory safety approach that stores just a single copy of a tag for each allocation, e.g., interspersed with the data itself in clusters to avoid the following overheads, which are especially severe for workloads with many small objects and frequent accesses to those small objects:
Page walk and TLB overhead to access separate metadata pages
Data cache unit (DCU) overhead to access separate metadata cachelines
Object lookaside buffer (OLB) pressure due to a high metadata to data ratio
Wasted memory due to padding to align data around metadata in line with allocations.

Certain (e.g., popular) workloads, such as browsers and OS kernels, are heavily skewed towards small objects, which exacerbates these overheads.

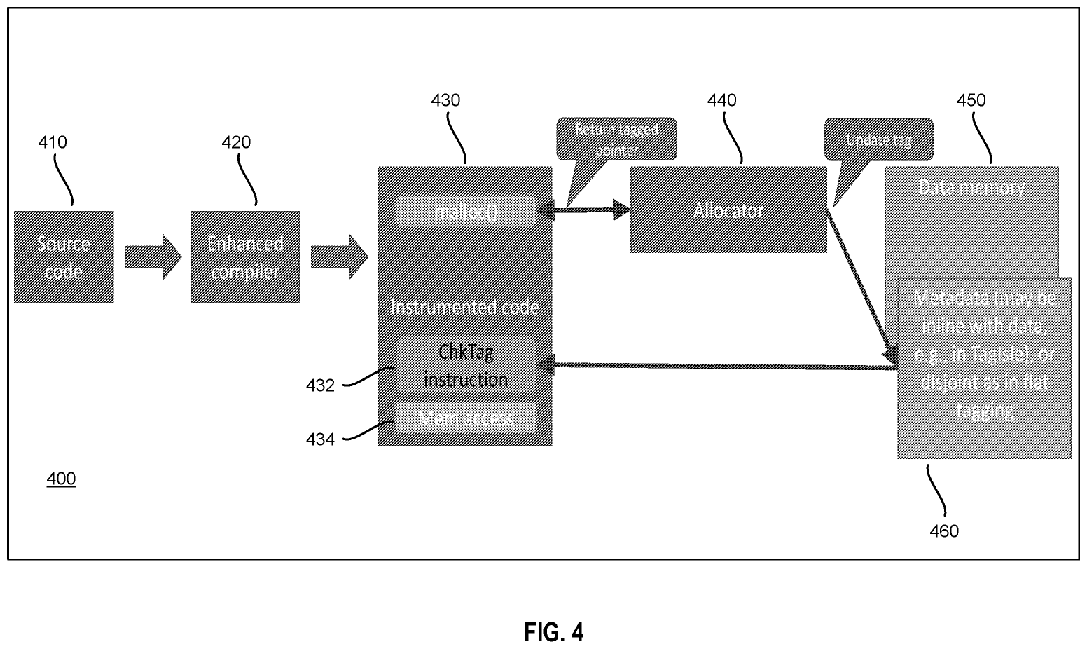

Examples herein are directed to interspersing islands of tags in line with bucketed data for locality (e.g., “TagIsle”). Certain examples herein of TagIsle bucketing involve using allocators (as known and/or described below, e.g., in connection with the description of FIG. 4), e.g., both in user space and kernel workloads, to avoid the need to store explicit bounds for allocations. Instead, in certain examples, bounds are defined implicitly depending on the region of memory to which a pointer refers, e.g., since every allocation slot in the region has an identical size. Avoiding storing bounds reduces the metadata to data ratio in the OLB, hence increasing its hit rate. It also reduces the overhead to handle an OLB miss. Furthermore, the clustered metadata approach herein facilitates prefetching an entire, tightly packed cluster of tags on each OLB miss.

Certain examples herein are not just limited to tags. For example, certain examples herein are used for clustering reference counts, e.g., to avoid padding allocations to meet alignment requirements in the presence of a reference count located adjacent to each allocation.

Plus, a dichotomy has traditionally existed separating memory safety mechanisms that permit linear indexing of metadata to simplify operating system (OS) and allocator management of metadata versus those that permit physical indexing of metadata to improve metadata/data coherency and caching. Examples herein collapse that dichotomy by supporting both linear and physical indexing options with a single metadata layout.

Examples herein (optionally) use compiler instrumentation to reduce hardware complexity.

In certain examples, memory technology allows for the storing of a single tag value for each allocation from a bucketing allocator directly next to that allocation. In certain examples, such memory technology may make it more challenging to prefetch blocks of multiple tags into OLB entries, since the tags are dispersed through memory with intervening data.

In certain examples, a flat memory tagging (e.g., ARM Memory Tagging Extension (MTE) and/or Intel® Memory Tagging Technology (MTT)) feature includes matching a tag encoded into a pointer against multiple copies of a tag stored alongside each (e.g., 16 Byte (B)) granule of data in memory. In certain examples, such memory technology (e.g., MTE and MTT) may impose a high level of redundant tag duplication, which consumes additional memory, requires expensive tag update operations, and hurts OLB hit rates.

In certain examples, memory technology (e.g., “OneTag”) avoids duplication using a specialized pointer encoding that allows locating a single copy of the tag in constant time along with bounds for the entire allocation. In certain examples, to achieve a single tag for any size of allocation with a flexible allocation layout and to provide slot polarity checks, such memory technology (e.g., OneTag) may use the linear address (e.g., 57 linear address (LA57)) bits to identify the location of a single tag and bounds for the given memory allocation. A power-of-two field in addition to the tag value in the pointer can be used to identify the location of the single tag and bounds information. That is, the power-of-two field indicates the power-of-two slot size the allocation fits within. As there may be one slot that best fits an allocation, a binary tree can be used to identify the metadata position for the associated tag and bounds stored in memory. In certain examples, such memory technology's sparse metadata may also hurt OLB utilization compared to the current disclosure. In certain examples, memory technology (e.g., OneTag) stores metadata on different pages from data, so it imposes additional page walk and TLB overheads, and it has lower cache locality. In certain examples, memory technology (e.g., OneTag) significantly reduces tag checking and tag setting overheads for workloads with frequent accesses to large objects relative to MTE and/or MTT, but it does not significantly reduce the overheads for workloads with frequent accesses to small objects, which may default back to checking individual tags per granule of memory.

In certain examples, Linear Inline Metadata (LIM) memory technology places metadata in line with data allocations. In certain examples, such LIM memory technology improves page and cache locality by storing metadata in line with the data, but that may disrupt data layouts, e.g., in ways that are incompatible with direct memory accesses (DMA).

In certain examples, region-based deterministic memory safety relies on bucketing allocators to implicitly determine bounds for allocations and to instrument pointer arithmetic such that out-of-bounds pointers are poisoned and hence rendered unusable for dereferencing memory. In certain examples, such region-based deterministic memory safety may lack enforcement for temporal memory safety.

To overcome the above technical problems, examples herein are directed to a technical solution that stores one copy of a tag and/or other metadata items for each allocation in line with allocation data, e.g., to reduce address translation and cache overheads by enhancing locality. Certain examples herein cluster the metadata to facilitate prefetching of multiple metadata items at once into an object lookaside buffer (OLB), e.g., to minimize disruption to object alignment and the need for padding.

Examples herein may address the performance and memory overheads used to enforce memory safety using other approaches for certain software, e.g., the types of software which operate on mostly small allocations. Examples herein may address hardware complexity concerns surrounding memory safety mechanisms.

Examples herein are directed to a processor (e.g., having instruction decoder circuitry and execution circuitry) to perform check tag (ChkTag) operation(s) that may include:
Checking address alignment.
Supporting multiple metadata formats.
Using x86-distinctive prefixes to elide unneeded checks to reduce overheads.

Further, the following disclosure describes a novel metadata format with associated instructions and other design elements for managing caches of metadata in that format.

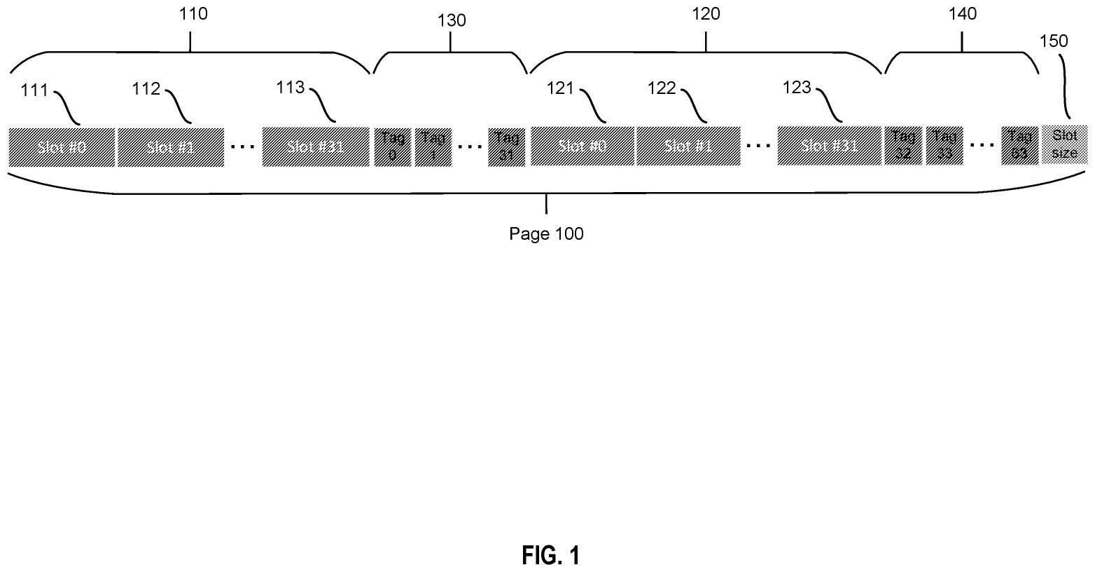

FIG. 1 illustrates metadata (e.g., tags) positioned relative to data in a page 100 according to examples of the disclosure. Certain examples herein are based on allocators (e.g., as known, further described below, illustrated in FIG. 4, and/or referred to as bucketing allocators), which assign allocations to regions, e.g., regions where every allocation slot in each region is identically sized. In certain examples, slot sizes do not need to be strict powers of two, e.g., arbitrary slot sizes may be supported, although setting constraints on slot sizes may result in a more compact encoding for slot sizes and permit the use of more optimized arithmetic for computing slot boundaries and metadata locations. For example, a fixed granularity (e.g., multiples of 8B or 16B) for slot sizes may be specified.

Consider a sample 8-bit slot size encoding for 4096-byte naturally aligned regions with 8-byte granules, in certain examples:
An encoded slot size of 0 indicates a single 8B granule.
The maximal encoded slot size denotes a single, 4088B slot, since the 2048B slot size that could naturally be encoded by multiplying 8B by 256 (encoded as 255) is not meaningful, e.g., only a single 2048B slot could fit, since two slots of that size would leave no space for metadata. Thus, the system may maximize the size of the single slot to 4088B to maintain alignment and leave space for one tag byte and one slot size byte.

In certain examples, no allocation crosses a slot boundary, e.g., every allocation fits entirely within its assigned slot, potentially with some padding to fill out the slot. In certain examples, different regions can have different slot sizes. In certain examples, the allocator is responsible for determining how many of each size of slot is needed to adequately satisfy the incoming stream of allocation requests. Region sizes may vary. Certain figures herein show region sizes matching underlying machine-supported page sizes, e.g., where that allows opportunistic reuse of existing microarchitectural structures such as TLBs to cache per-region information. However, other region sizes are also possible. Certain examples allow for the spanning of multiple machine pages with a single region, e.g., specifying the split point for the first slot in each page. This disclosure refers to “pages” but can be generalized to other region sizes.

FIG. 1 illustrates slots (e.g., slot 111, slot 112, slot 113, slot 121, slot 122, slot 123) grouped into clusters (e.g., cluster 110 including slot 111, slot 112, slot 113, etc.; cluster 120 including slot 121, slot 122, slot 123, etc.), e.g., with each cluster having an associated cluster (e.g., “island”) of metadata (e.g., island 130 for cluster 110, island 140 for cluster 120) stored next to it. In certain examples, the metadata clusters can be stored before or after the associated data, or even at an offset inside of the associated data. For example, to minimize contention for “hot sets” in cache, some linear or physical page frame number bits or an index stored in the page can vary the slot within the data cluster that the metadata sits before or after. For example, on one of the pages, the metadata could be configured to be stored between the second and third slots, while on another page, the metadata could be configured to be stored between the 14th and 15th slots. In certain examples, if those pages have the same slot size, their metadata could contend for the same cache sets unless they had that sort of variation in the relative positions of their metadata.

In certain examples, the slot size (e.g., slot size 150) may be positioned at the end of each page to minimize disruption to data alignment, or it may be stored at some other position in each page. In certain examples, if this induces concerns about hot cache sets, its position could alternate between the beginning and end of pages depending on a bit from their linear or physical page frame numbers. Alternatively, it could be stored in a separate structure, e.g., the page table entry (PTE) for the page, especially if 128-bit PTEs are in use, or even a dedicated table. In certain examples, the slot size storage is to be indexable by the appropriate type of address for the addressing used to index the metadata. In certain examples, linear metadata indexing provides substantial flexibility in locating slot size information, whereas physical metadata indexing requires that the slot size be indexable using physical addresses as well.

In certain examples, groups of fewer than N slots at the ends of pages can use reduced-size tag clusters. For example, if just three slots fit after final 32-slot cluster assuming N=32, then place three tags in the final metadata cluster.

In certain examples, the use of large and huge pages can scale up this approach to handle larger allocations than would fit, or would fit efficiently, on a small page.

### Allocator Enabling

In certain examples, allocators (e.g., as known, further described below, and/or illustrated in FIG. 4), are enhanced to reserve space for metadata in line with data. In certain examples, allocators are to update metadata values when allocating and freeing allocations. In certain examples, only a single copy of each type of metadata would need to be updated per allocation, which reduces overheads, especially for large allocations. In certain examples, an allocator is to lay out memory carefully to minimize overheads. For example, an allocator may prefer slots that minimize unusable space at the end of a page and tag clusters spanning cacheline boundaries.

In certain examples, the tagged range(s) can be specified via linear range register(s) or a PTE bit or a linear or physical table specifying which regions are tagged and what the region size is that contains identically sized slots specified by a slot size stored at some location such as the end of the region. That region size may match the underlying machine page size, or it may differ.

### Slot Polarity Checks

In certain examples, slot polarity checks implement deterministic adjacent overflow checking independent of tag values, e.g., to allow use of tags for enforcing temporal safety without complex adjacency rules.

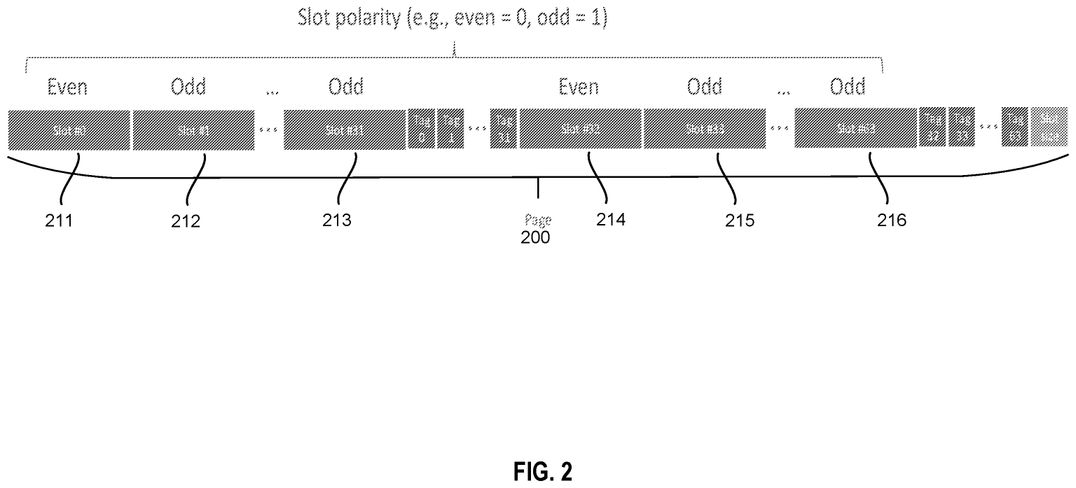

In certain examples, slot polarity is defined in terms of whether a slot is “even” or “odd”, arbitrarily defining the first slot in the page as “even” and alternating thereafter throughout the page. FIG. 2 illustrates even and odd slot polarity for a page 200 according to examples of the disclosure. In the example of FIG. 2, slot 211 (as slot #0, the first slot in the page) is even, slot 212 (as slot #1, the second slot in the page) is odd, slot 213 (as slot #31, the 32^{nd} slot in the page) is even, slot 214 (as slot #32, the 33^{rd} slot in the page) is even, slot 215 (as the slot #33, 34′ slot in the page) is odd, and slot 216 (as slot #63, the 64′ slot in the page) is even.

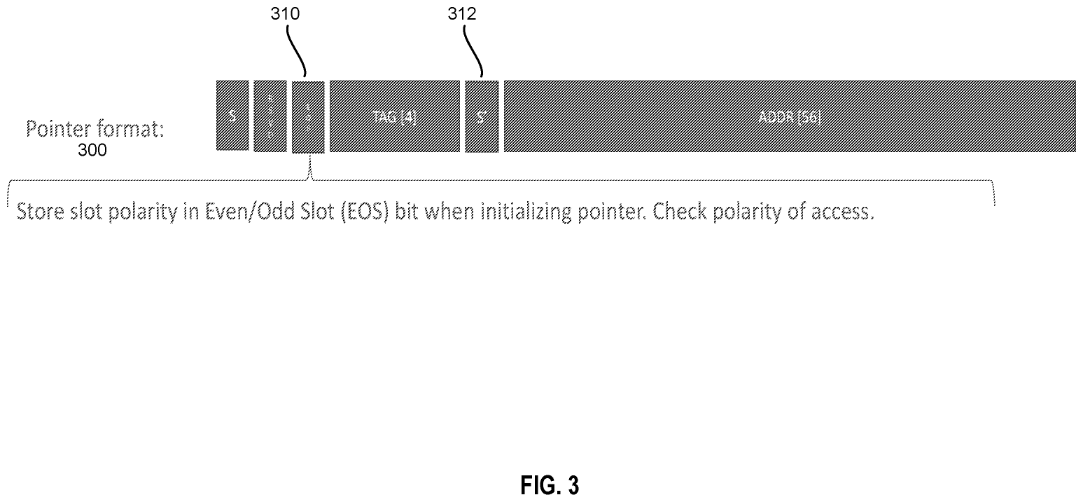

In certain examples, the expected polarity for the object to be accessed can be encoded into the pointer at allocation time. For example, it can be placed into one of a number of linear address masking (LAM) ignored bits and labeled “EOS” for “Even-Odd Slot”. FIG. 3 illustrates an example pointer format 300 including a field 310 for an expected polarity for an object to be accessed according to examples of the disclosure.

In certain examples, when an access is performed, the processor checks that the polarity of the slot being accessed matches the value of the EOS bit, e.g., and in case of a mismatch, an exception is generated.

More compact encodings are possible in some cases. For example, if the processor automatically checks slot polarity during each access, the slot polarity can be exclusive ORd (XOR-ed) into the S or S′ bit (e.g., in field 311, where the paging requires the bit value to be identical) (e.g., a user pointer if 0 and a supervisor pointer if 1) both at allocation time and again during each access prior to the canonicality check. In certain examples, if the polarities match at both times, then the canonicality check will succeed, e.g., otherwise, an exception will be generated, which indicates that a memory safety violation occurred in this case.

Certain examples herein extend the slot polarity checking concept to bucketing allocators without requiring power-of-two slots to be encoded into pointers.

Slot polarity checks can be performed using ordinary arithmetic instructions. It may be useful to fence such instruction sequences to enforce memory safety hardening in transient execution.

### Minimizing Hardware Complexity Via Instrumentation

The following first describes an example that is less complex to implement in hardware, and then describes a more complex example that supports checks for legacy binaries and may also improve performance.

In certain examples, the less-complex implementation uses an enhanced compiler to instrument code with explicit instructions to check accesses. FIG. 4 illustrates a block diagram 400 comprising an enhanced compiler 420 to instrument source code 410 with explicit instructions to check accesses according to examples of the disclosure, as well as an allocator 440 to allocate one or more portions of a memory (e.g., data memory 450) to a program, application, or other software. An allocator (e.g., allocator 440) may also be referred to by other names (e.g., memory allocator), may be implemented within system software (however, embodiments are not limited to software implementations of an allocator), and may perform allocation as known and/or according to or in connection with any technique described in this specification.

In certain examples, in the resulting instrumented code 430 each memory access (e.g., memory access 434) is preceded by a ChkTag instruction (e.g., ChkTag instruction 432) that operates as follows:
(1) A source memory operand encodes the access range:
   Base register: First byte of access
   Effective address: Last byte of access
   Displacement can encode fixed access size
   (Scaled) index can encode dynamic access size
(2) ChkTag checks that:
   Entire range is within a single slot
   Slot polarity check succeeds
   Tag in source memory operand base reg matches tag in inline metadata
(3) ChkTag skips checks for accesses outside bucketed heap (and maybe global and/or stack) range(s), if specified.
(4) ChkTag can perform ordinary linear accesses to inline metadata initially to reduce hardware complexity.
(5) ChkTag generates an exception if any check fails.
   Some examples may use a different encoding of the access range, e.g., with the base register+scaled index register (if specified) indicating the first byte of the access and the displacement indicating the access size, or the base register+displacement indicating the first byte of the access and the scaled index register indicating the access size.

In certain examples, ChkTag is orthogonal to particular metadata layouts and formats. For example, it can also support flat tag tables and/or OneTag metadata located using an additional power field in the pointer. The LessTag variant of the OneTag approach could also be used.

In certain examples, LessTag can be extended to balance LA57 compatibility with avoiding the need to load multiple metadata items for large or unaligned accesses. This could be accomplished by duplicating metadata according to the LessTag schema but including bounds for the full range of the object in every copy of the metadata. In certain examples, the allocator (e.g., allocator 440) is to pad allocations to result in the assignment of a sufficiently large slot size to space out, in memory (e.g., data memory 450), the metadata (e.g., metadata 460) adequately to fit the full bounds for the entire allocation in each copy of the metadata.

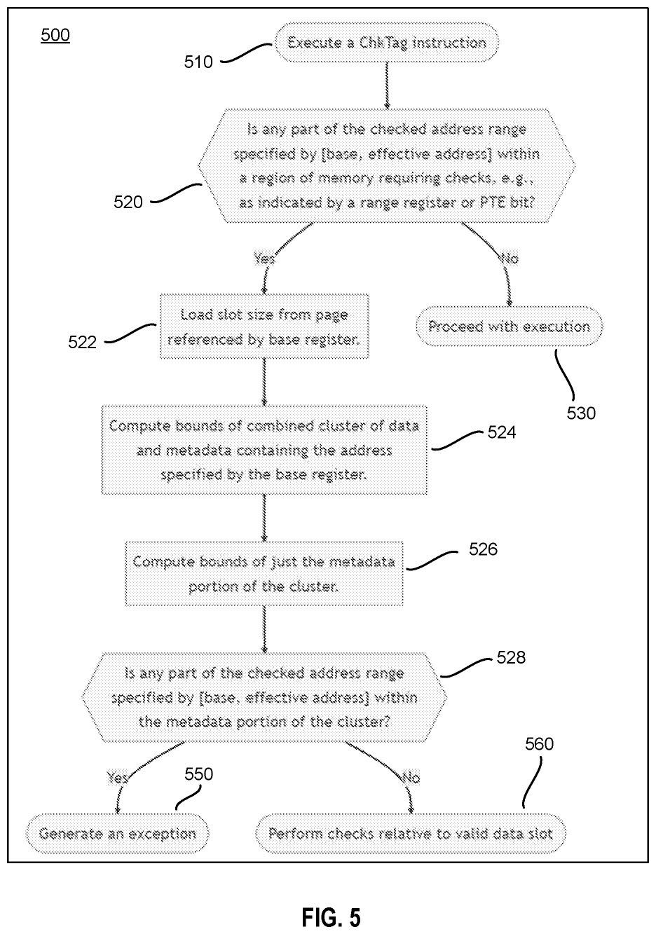

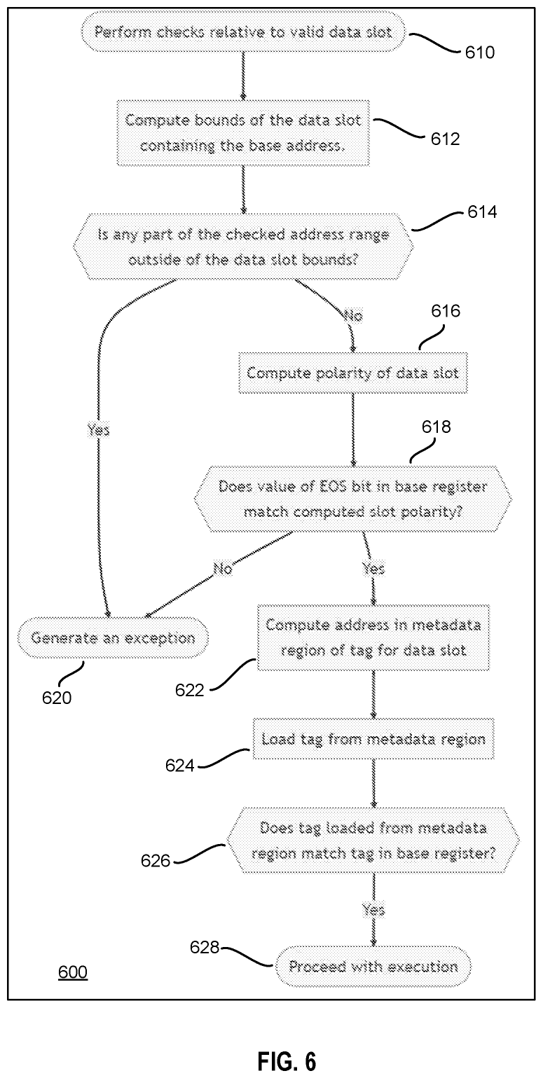

Example ChkTag operations (e.g., for a ChkTag instruction) are depicted in the following FIG. 5 and FIG. 6.

FIG. 5 is a flow diagram illustrating operations of a method 500 for performing a check tag (CkhTag) operation according to examples of the disclosure.

In 510 of method 500, execution of a check tag (e.g., ChkTag) instruction begins. In 520, it is determined whether any part of the checked address range specified by [base, effective address] is within a region of memory requiring checks, e.g., as indicated by a range register or page table entry (PTE) bit. If so, method 500 continues in 522. If not, execution proceeds in 530.

In 522, the slot size from the page referenced by the base register is loaded. In 524, bounds of a combined cluster of data and metadata containing the address specified by the base register is computed. In 526, the bounds of just the metadata portion of the cluster is computed.

In 528, it is determined whether any part of the checked address range specified by [base, effective address] is within the metadata portion of the cluster. If so, then in 550, an exception is generated. If not, then in 560, checks relative to a valid data slot are performed (e.g., 560 in FIG. 5 may correspond to 610 in FIG. 6 described below).

FIG. 6 is a flow diagram illustrating further operations of a method 600 for performing a check tag (CkhTag) operation according to examples of the disclosure.

In 610 of method 600, performance of checks relative to a valid data slot begins (e.g., 610 in FIG. 6 may correspond to 560 in FIG. 5 described below). In 612, bounds of the data slot containing the based address is computed.

In 614, it is determined whether any part of the checked address range is outside the data slot bounds. If so, then in 620, an exception is generated. If not, then method 600 continues in 616.

In 616, polarity of the data slot is computed. In 618, it is determined whether the value of the EOS bit in the base register matches the computed slot polarity. If so, then in 620, an exception is generated. If not, then method 600 continues in 622.

In 622, the address in the metadata region of the tag for the data slot is computed. In 624, the tag from the metadata region is loaded. In 626, it is determined whether the tag loaded from the metadata region matches the tag in the base register. If so, then in 628, execution proceeds.

In certain examples, ChkTag combines with Linear Address Masking (LAM) to cause data accesses to mask one or more non-address bits in pointers, including tag bits, which also provides compatibility with (e.g., legacy) uninstrumented libraries. In certain examples, accesses from uninstrumented libraries will be unchecked.

In certain examples, compiler static analysis can elide and coalesce checks to reduce overheads from checks as well as code bloat due to added instructions.

In certain examples, the ChkTag opcode can be allocated from the no-operation (NOP) space, e.g., for single-binary compatibility with non-ChkTag-capable processors.

In certain examples, an overall enable bit is defined for ChkTag to disable its operation selectively, e.g., to support statistical sampling for memory safety issues (e.g., RTCALL). For example, a bit could be defined in a model specific register (MSR) (e.g., CR4). It may also be useful to allow userspace code to enable and disable ChkTag without needing to invoke supervisor mode code. For example, a userspace MSR could be defined for that purpose, or a flag bit could be used as the control.

In certain examples, access to metadata can be controlled implicitly using ChkTag, including the following:
ChkTag generates an exception upon any attempt to access metadata due to that access not being in a valid slot.
   Metadata is defined as being outside of any slot.
Omit ChkTag prior to valid metadata update in allocator.
Metadata, like data, may be susceptible to legacy code lacking ChkTag instrumentation.

In certain examples, metadata synchronization may include:
ChkTag adheres to standard X86 memory consistency model.
   Without fencing data accesses from tag updates.
Transactional Synchronization Extensions (TSX) Restricted Transactional Memory (RTM) can be used to address race conditions by keeping metadata checks and the corresponding data accesses in the same transaction. In certain examples, compilers would need to balance the costs of frequently entering and exiting small transactions with the overheads from excessive aborts due to oversized transactions.

ChkTag can be made to operate without depending on LAM:
Allow specifying a destination operand that will receive the base register value from the source memory operand, but with the encoded metadata bits in the pointer replaced with canonical/sign extension bit values.
For binaries running on non-ChkTag-capable machines, the same register may be specified for both the destination and the source memory operand base register operands in ChkTag instructions. In certain examples, ChkTags will be NOPs, so the base register will be unmodified.
However, this may impose extra register pressure and register movement instructions.

Another alternative is to place the computed effective address for the memory operand supplied to ChkTag into the destination register and then supply that to subsequent memory accesses. If this instruction variant were encoded as a prefixed variant of a load effective address (LEA) instruction, that would also support backward compatibility. This may limit reinterpreting portions of the memory operand as having other significance, such as specifying the data access size, since the full effective address would likely indicate the start of the access, whereas the proposal above to indicate the size of the access using the portions of the memory operand other than the base register would essentially set the effective address to be the end of the access. The size of the data access to be checked may be encoded by using multiple possible prefixes to specify that tag checking is needed. For example, one prefix may indicate that a 4-byte access requiring a check is to be performed, whereas a second prefix may indicate than an 8-byte access is to be performed. The various approaches described later for controlling whether checks are automatically generated for data accesses may also be applied to LEA instructions. Setting aside backward compatibility, new instructions could be defined accepting an input memory operand, a destination register to contain the computed effective address, and an immediate (or other value encoded into the instruction, such as a ModR/M digit) or register operand to specify the access size. Avoiding the need to encode the memory operand twice (once for the check and once for the access) may reduce code size overhead in some instances.

Other metadata layouts and formats can be supported. For example, alternative examples of ChkTag could operate on the linearly indexed flat tag table formats from the Hardware-Assisted Address Sanitizer (HWAsan) or Memory Corruption Detection (MCD) or the physically indexed, flat tag table (e.g., in ARM Memory Tagging Extension (MTE)). Tag tables may also be hierarchical. In examples such as these that involve redundant copies of tags, ChkTag could recognize the repeat (REP) prefix to allow hardware to accelerate checks on those multiple copies with the number of copies or the combined length of all tags to be checked or all data to be accessed specified in the RCX register. Some examples may check the tag for the first address to be accessed and the last address to be accessed to avoid the overheads of checking any intervening tag values, although this introduces the potential for missing a mismatched intervening tag value. A distinct instruction encoding or an operand value may indicate that the first and last addresses should be checked and that intervening tag values should be skipped.

For example, the representation of ChkTag in that case for checking a single tag copy could be represented using the following pseudocode:

```
function exe_chktag(ptr: MemOp) −> unit = {
  if CR4_CHKTAG == b1 then {
    let ea = compute_ea(ptr);
    let la = compute_la(sign_extend(ea[56 .. 0], 64));
    let tag_tbl_offset = shr(la, 4);
    let tag_addr = TAG_TBL_BASE + tag_tbl_offset;
    let tag_mem = movb(tag_addr);
    let tag_ptr = ea[62 .. 57];
    if tag_mem[5 .. 0] != tag_ptr then {
      throw CTM(la, tag_ptr);
    };
  };
}
```

CR4_CHKTAG could be a CR4 bit indicating whether ChkTag instructions are currently enabled. TAG_TBL_BASE could be a linear base address for a tag table specified in an MSR. CTM could be a defined type of exception for “ChkTag mismatch”.

Since the compiler may already be instrumenting code in these examples, ChkTag may save the computed effective address in a destination register to avoid a redundant LEA instruction if one would otherwise be needed.

If the effective segment for the memory operand has a non-zero base address, ChkTag may add that segment base address when computing the linear address. Some examples may use a compact instruction encoding that specifies a single register in the opcode without requiring a full memory operand to be encoded. A segment override prefix may still be applied to such instruction encodings, and ChkTag may perform segment base addition for those instructions. The effective segment may also be determined for that compact instruction encoding by applying similar rules to the specified register as would be applied to the base address register in a memory operand, e.g., using an effective segment of SS (for “Stack Segment”) when the RSP register is specified.

In some examples, the tag may be extracted from the linear address instead of from the effective address.

In some examples, the LAM mode-based rules for generating a canonical linear address from an input pointer may be applied.

In some examples, the offset within the tag table may be computed based on the effective address.

In some examples, one or more software-configurable address ranges may be checked to determine whether the data access is within the specified range and enable or disable checking for all or a portion of the access depending on whether all or a portion of the access is within or outside of the specified ranges.

In some examples, the size of the access may be encoded into the instruction, e.g., via typical memory operand encodings or via a specialized encoding such as a digit embedded in the opcode. This information may be used to determine the complete set of aligned memory granules that will be accessed so that all of the associated tag copies may be checked.

In some examples, checks may be disabled for accesses in one or more specified privilege levels, e.g., supervisor level. Checks may be disabled if a bit or value in the page table structure indicates no tag checks are required for a particular page of memory. Checks may be disabled for certain memory ranges as set by privileged software.

In certain examples in which a ChkTag instruction that performs a complete memory safety check operation may not be adaptable to alternative metadata formats, various simpler instructions that can be combined to perform a complete memory safety check may be defined. If one or a few of the instructions is inapplicable for some alternative metadata format, the remaining instructions may still be applicable and help to partially accelerate the operation.

For example, the following instructions may be useful for memory safety checks:
LAMEXTR r64, r64: Extract the ignored bits from the source operand and place in the destination operand. Replaces two instructions with one.
LAMMASK r64, r64: Mask out the ignored bits from the source operand and place the masked value in the destination operand. Replaces three instructions with one.
LAMLEA r64, m64, imm8: While computing the effective address for the tag table access, ignore LAM bits in the base register and shift the base register right by the number of bits specified in the immediate. Replaces four instructions with one. Could extend even further to (e.g., always) add the value from a tag table base address MSR to avoid a 2G displacement limitation.
LAMCMP m8, r64, imm8: Load metadata value from memory operand. Mask the ignored bits in the source register operand by AND-ing with the immediate to allow selecting a configurable set of pointer bits to be compared to the loaded metadata. Compare the masked pointer bits to the bits loaded from memory operand and set flags similarly to the x86-64 CMP instruction. Replaces five instructions with one. In certain examples, a 4-bit shift right operation may be performed on the loaded metadata value prior to the comparison to compare against the most significant nibble of the stored metadata. The need for the shift may be determined from the pointer in the source register operand according to a rule, e.g., that if the fifth least-significant bit of the pointer is set, then a shift is needed, corresponding to a 16-byte data granule size. Some examples may accept a separate operand or instruction encoding to indicate whether a shift is needed. Some examples may use different metadata access sizes, pointer and mask widths, and shift amounts.
INT3NE: Generate an INT3 on the not-equal condition. The internal micro-operation (uop) branch could be set to (e.g., always) predict that the INT3 will not be generated. Replaces two instructions. In some examples, a different exception or software interrupt may be generated. In some examples, a different condition may be specified for generating the interrupt or exception.
GETTAGBASE r64: Retrieve the base address of the tag table into a specified register.
INITTAGSCAN r64, m8: Prepare register values, e.g., in preparation for a REPE SCASB (Repeat While Equal Scan String Byte) operation to check that a range of values in the tag table matches a pointer tag:
Set RAX to the tag value extracted from the pointer.
Set RCX to the length of the tag table portion that would need to be scanned based on the data access size specified in first source operand.
Set RDI to the first byte that needs to be scanned within the tag table to be scanned.
The computations above may vary depending on the size of the tag. For sub-byte tags, e.g., 4-bit tags, some examples may also provide a smaller scanning instruction, e.g., SCASN for “Scan String Nibble”. The memory operand may supply a nibble address, and the LAM transformation may be adjusted to mask one fewer bit in the address, since there are twice as many nibbles as bytes to address. Alternatively, an additional operand may specify whether to start the scan at the first or second nibble in the specified starting byte. To provide constant time operation, some examples may cause some or all Scan String instructions to scan all bytes within the specified range, even if their normal behavior would be to stop partway through the specified range. This behavior may be selected based on a mode, e.g., whether ChkTag is enabled, or an instruction encoding.

Some examples may cause SCASB instructions to mask upper bits in scanned bytes above the tag size. This behavior may be selected based on a mode, e.g., whether ChkTag is enabled, or an instruction encoding.

Multiple instruction encodings could be defined for checking loads versus stores, and along other delineations between different types of accesses, and separate enable bits could be defined for each of those.

As an alternative to performing new tag comparison checks within ChkTag or a new INT3NE instruction, certain examples rely on another check. For example, by XOR-ing the loaded tag value into the original pointer and propagating that through to the pointer value that will actually be used in the attempted data access with LAM disabled, that would induce a canonicality violation fault when there is a tag mismatch. This XOR-ing could be performed by new instructions such as ChkTag or by equivalent sequences of other instructions.

In certain examples, ChkTag can also check address alignment, which may be useful for avoiding the need to load multiple tags, for example. By checking that an access is aligned such that it will not cross a granule boundary, ChkTag can ensure that loading just a single tag copy is sufficient to check the access. Various ChkTag encodings can be specified to indicate the acceptable alignment of the addresses passed to the instructions. In certain examples, it is unnecessary from a tag-checking standpoint to support specifying alignments any greater than the tag-checking granularity, e.g., 16 bytes, but it may still be convenient for the program to be able to specify larger alignments to check, e.g., to check for performance bugs due to alignments that are smaller than an associated single instruction, multiple data (SIMD) operation.

### Accelerating Metadata Checks Using the TLB and an Object Lookaside Buffer (OLB)

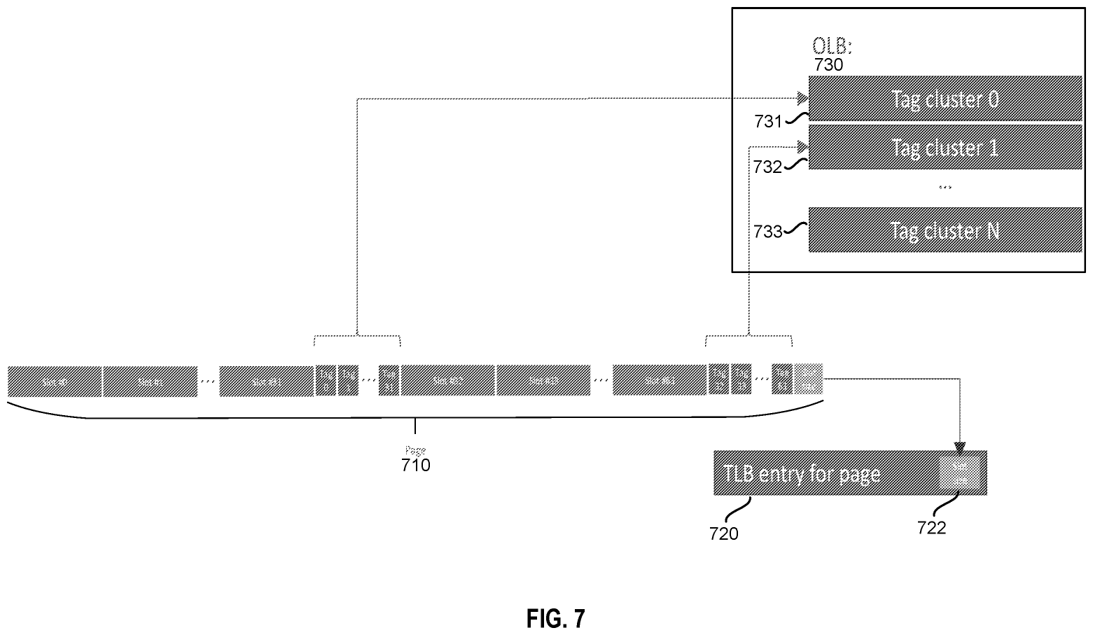

FIG. 7 illustrates accelerating metadata (e.g., tag) checks using a translation lookaside buffer (TLB) and an object lookaside buffer (OLB) according to examples of the disclosure. For example, a slot size (e.g., slot size 722) for a page (e.g., page 710) may be cached or stored in a TLB entry (e.g., TLB entry 720) for the page, and/or one or more tag clusters (e.g., tag cluster 731, tag cluster 732, tag cluster 733) may be cached or stored in an OLB (e.g., OLB 730).

In certain examples, a new invalidate slot size “InvSlotSz” instruction (e.g., that can be executed from both user and supervisor mode) is to invalidate stale slot size values cached in TLBs. In certain examples, the instruction allows pages to be specified that are writable in the current context (e.g., if a page is specified that is not writable in the current context, then InvSlotSz generates an exception). In certain examples, a user inter-processor interrupt (IPI) may be used to invoke a handler to invoke InvSlotSz on each HW thread. Alternatively, if the slot sizes for pages rarely change, an ordinary IPI and ordinary TLB invalidation instructions can be used instead. InvSlotSz may leave the rest of the TLB entry intact and only invalidate the slot size to avoid necessitating a new page when reloading just the slot size.

In certain examples, an object lookaside buffer (OLB) can be defined to cache metadata loaded from the ordinary data cache. Having a dedicated OLB can reduce overheads by avoiding consuming contended microarchitectural buffers for ordinary memory accesses. In certain examples, the OLB utilizes a coherency mechanism, e.g., where the TagIsle OLB is indexed by the addresses of metadata clusters.

### Caching Metadata in Sidecars Based on Physical Metadata Indexing

In certain examples, metadata may be cached in sidecars attached to data cachelines, e.g., rather than in a core-level OLB, such that the metadata is available along with loaded data. In certain examples, the clustered inline metadata layout disclosed herein is amenable to both linear and physical indexing for metadata, hence supporting both the OLB and sidecar caching approaches.

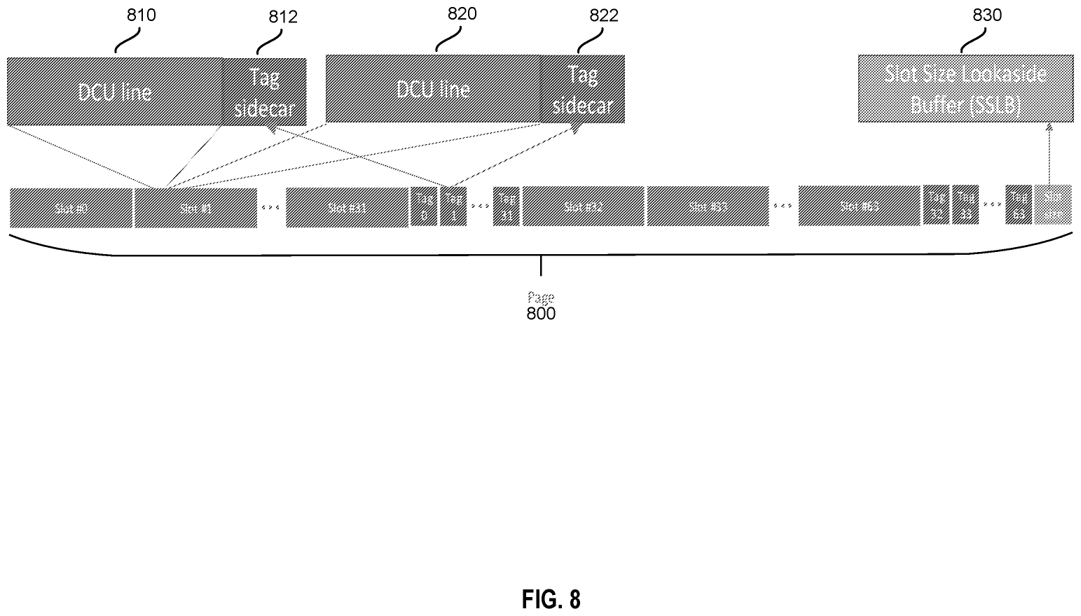

An example sidecar-based caching approach suitable for this metadata layout is illustrated in FIG. 8. FIG. 8 illustrates caching metadata in memory sidecars based on physical metadata indexing according to examples of the disclosure. For example, a DCU entry format may include a field to store a cacheline (e.g., cacheline 810 from page 800, cacheline 820 from page 800) and a field (e.g., tag sidecar 812, tag sidecar 822) to store a tag corresponding to the cacheline.

In certain examples, when loading a cacheline into the DCU, the processor would lookup tags in the same physical frame number (PFN) to pull them into the associated sidecar. In certain examples, a page configuration bitmap indexed by page frame numbers would indicate tagged pages. In certain examples, it would also specify the page size (e.g., small, large, or huge) to allow locating the slot size field. For example, this could be accomplished using a two-bit encoding (0=untagged, 1=tagged small page, 2=tagged large page, 3=tagged huge page). The appropriate configuration value could be duplicated for every (e.g., 4K) aligned region in the whole page in the case of large and huge pages, or a hierarchical structure could be defined. This would also be an option for indicating which pages are tagged with a linear metadata indexing approach, if ranges are insufficiently flexible and software does not want to give up a PTE bit for that purpose. Instead of indicating page frame size for linear indexing, in certain examples, a bitmap could be used, since the paging structures themselves would specify the page size. On the other hand, the arrangement of metadata such as the slot size field might not match the page sizes specified in the paging structures, e.g., a single slot size field may cover a whole 2M-aligned region that is fragmented into many 4K pages, even if linear metadata indexing is used. In that case, it would be useful for the page configuration bitmap to specify the arrangement of metadata independently of page sizes.

In certain examples, since the TLB is linearly indexed rather than physically indexed, a separate slot size lookaside buffer (SSLB, e.g. SSLB 830) could be defined instead to cache the slot size for each page frame. The indexing for the SSLB could be defined such that it is able to detect requests for a slot size anywhere within the page frame that it covers, for multiple page frame sizes, e.g., without that request checking the page configuration bitmap.

In certain examples, an InvSlotSz instruction that would invalidate slot size specifications cached in TLBs would also invalidate them when cached in SSLBs.

In certain examples, sidecars only exist at the Li level, so the tag sidecars and SSLB would preferentially fill from the DCU/L1 cache, but they could instead be filled from deeper cache levels if misses occur at higher levels. Alternatively, tag sidecars could be added to deeper levels of cache as well and would hence fill from those corresponding deeper levels.

In certain examples, sidecars could be combined with an OLB to optimize both load and store performance. In certain examples, loads would be optimized by having tags readily available from a sidecar for each load, and stores would be optimized when there is an OLB hit, e.g., because that would avoid the need to wait for the data cacheline to become available with its sidecar prior to deciding that the store can safely retire. In certain examples, the OLB is specialized to only check stores, which would increase OLB hit rates for stores. In the case of an OLB miss, a complex OLB miss handler can potentially be avoided in lieu of simply waiting for the cacheline to naturally arrive with its sidecar containing the metadata. However, that may increase OLB complexity in some ways to accommodate marking each OLB entry slot (e.g., one tag within the overall OLB entry) with whether it is valid. The OLB entry could be incrementally populated as more accesses to different slots covered by the same OLB entry are accessed. In certain examples, this would also increase complexity for checking whether the OLB is able to satisfy an incoming request. Combining an OLB with sidecars could also potentially reduce complexity and performance overhead for maintaining OLB coherency with the generic caches. The OLB could potentially proactively cache tag metadata received in sidecars for loads in the expectation that stores will subsequently target the same locations, although that may hurt OLB hit rates in some workloads with mostly disjoint addresses for loads and stores.

In certain examples, a move tag (MovTag) instruction is included to update metadata. In certain examples, it would take exclusive ownership of all cachelines in that slot that are active anywhere in cache hierarchy and update their sidecars, plus actual tag storage in DCU data region. This is analogous to what would be used for physically indexed flat tag tables in alternative architectures, such as ARM Memory Tagging Extension (MTE), except that certain of those architectures would additionally require updating duplicated tags in memory. In certain examples, TagIsle has just a single stored tag for the entire allocation, e.g., such that there is no need for multiple MovTag variants for different object sizes; all sizes are covered with one tag.

Furthermore, in certain examples, despite the sidecar entries for multiple cachelines within a slot duplicating the tag for that slot, only one tag sidecar needs to be checked for each access, regardless of the range of the data access, since the entire slot has the same tag value. This property could even allow optimizing the sidecar updates so that if a single sidecar covering multiple data granules within a cacheline, e.g., four 16B granules in a 64B cacheline, has multiple of those granules within a single slot, just a single sidecar slot would need to be populated with the tag. In certain examples, the processor would simply need a consistent rule for locating the valid sidecar slot, for example, (e.g., always) picking the lowest address within the current sidecar such that the address is also covered by the slot.

In certain examples, when lines with dirty metadata are evicted, metadata is overwritten unconditionally. In certain examples, if tag sidecars exist at all levels of the cache, then performing repeated overwrites directly to memory (e.g., DRAM) may impose substantial additional overhead. Instead, in certain examples, a dedicated metadata cache at the memory controller could help to absorb repeated overwrites.

### Adding Automatic Metadata Checks

In certain examples, automatic checks are performed for each memory access to reduce or eliminate the need for ChkTag instrumentation.

In certain examples, this may:
Add support for checking accesses in legacy binaries
Shrink code size
Help to enable combined data/tag cache accesses for physically indexed metadata, (although perhaps macro-op fusion could still allow that even for ChkTag)

Such examples might also include:
Fencing between tag updates and affected data accesses in implementations with an OLB.
A ChkTag mode for allowing compiler static analysis to elide and coalesce checks in programs amenable to recompilation.

To reduce code size overhead and to enforce memory safety in legacy binary code and assembly language snippets, in certain examples, a decoder could inject ChkTag micro-instruction sequences ahead of some or all types of memory access instructions. For example, instead of automatically generating checks for all types of memory access instructions, automatic checks may be generated for a subset of instructions, e.g., those that are most common, and rely on separate ChkTag instructions to be paired with other types of instructions. Other microarchitectural techniques may also be used to automatically perform checks for some or all types of memory accesses. Equivalently in software, a binary instrumentation tool could transform the code to add ChkTag instructions ahead of memory accesses, although this may only address compatibility and stored code size concerns, not runtime code size concerns. Checking every memory access may impose unacceptable performance overhead. Thus, a prefix may be attached to memory access instructions to indicate that checks should be skipped for those instructions when the compiler is able to determine via static analysis that the accesses are (e.g., always) safe. Alternatively, the polarity of the prefix could be flipped to perform checks when the prefix is present. The polarity may be configurable via a mode setting (e.g., an MSR bit), or it may even vary according to distinct code regions within a program. For example, a bitmap may specify via a bit for each code page what the polarity is for that page. Alternatively, a new instruction may be used to set the polarity appropriately when entering a new code region. For example, code size may be reduced by using prefixes to selectively remove checks from code regions generated from certain (e.g., “unsafe”) languages such as C/C++ and conversely using prefixes to selectively add checks to code regions generated from (e.g., “safe”) languages such as Rust. Certain memory operand encodings may also imply the safety of the access, hence allowing checks to be skipped. For example, instruction pointer (IP) (e.g., RIP) relative accesses and those with no base address register are directly to global variables, which the compiler may be able to analyze. Likewise, in certain examples, return stack pointer (RSP) relative accesses are directly to stack variables. Thus, it may be safe to skip checks for RIP-relative and RSP-relative accesses and those with no base address register. Other aspects of memory operand encoding may also be used to modify automatic check generation. For example, the presence of an index register may be associated with a dynamically computed array offset, which may benefit from tag checking regardless of the base address register that is used or the lack of a base address register. In some examples, tag checking may be elided when certain base address registers are specified or no base address register is specified regardless of whether an index register is also specified.

In some examples, the indicator may be used as a hint for whether checks are needed for specified instructions. The processor may optionally ignore hints.

To avoid the overheads of adding prefixes to modify automatic check generation behavior, register namespaces may be defined to modify automatic check generation behavior based on what register is used to store the base address in a memory operand. The selection of what base address registers indicate the need (or hint at the usefulness) for a tag check may be informed by Application Binary Interfaces (ABIs). For example, a compiler is unlikely to know statically that a parameter or return value is safe, so it generally will need to be checked. To allow efficient dereferencing of tagged pointers passed as arguments or returned from functions, all registers used for argument passing or to return values may be included in the tagged register namespace, i.e., the namespace of base address registers that indicate or hint at the need for a tag check. This may naturally exclude checking of many global and stack accesses, which the compiler can often statically determine to be memory-safe, since those accesses may often be encoded using a base address register that is outside the register set used for passing arguments or return values. Other aspects of memory operand encoding may also be used to modify automatic check generation. For example, the presence of an index register may be associated with a dynamically computed array offset, which may benefit from tag checking regardless of the base address register that is used or the lack of a base address register. In some examples, tag checking may be elided when certain base address registers are specified or no base address register is specified regardless of whether an index register is also specified. Other considerations may influence the selection of registers for namespaces, such as the proportion of pointers needing checks. Register namespaces may be specified dynamically, e.g., based on a bitmap indicating which registers are included in the checked namespace.

Register namespaces and prefixes for modifying automatic check generation may be usefully combined.

Some memory operand encoding bits are only used in certain memory operand formats, but those bit locations are still present in certain other memory operand formats. Using those bit locations when they are available to control whether to generate checks can reduce code bloat compared to adding a separate byte as an indicator.

For example, one or more X bits are encoded in REX, REX2, 3-byte VEX, and 4-byte EVEX prefixes in x86-64 and Intel Advanced Performance Extensions (APX). The primary purpose for those bits is to allow selecting an index register with a higher number than can be selected without using X bit(s). However, many memory operand formats do not allow the selection of an index register, and the X bit(s) are available to be repurposed in those formats. An X bit can be used to indicate whether a check should be automatically generated when the prefixed instruction is a type from which a check can be automatically generated.

If an instruction is not already preceded by a prefix containing a location for X bit(s), the compiler may add one with just an X bit set. If an instruction is preceded by a VEX or EVEX prefix that does not contain location(s) for X bit(s), the compiler may replace that prefix with a lengthened one that does contain location(s) for X bit(s).

X bit(s) that are set in memory operand encodings that do not otherwise make use of those bits are ignored. Thus, backwards compatibility is preserved for running binaries on processors lacking ChkTag support.

An alternative to X bit(s) is to use other bits in the instruction encodings, e.g., W bit, e.g., in some SSE instruction encodings that do use X bit(s) but ignore the W bit. The W bit is unused in LEA instructions, so it may also be especially useful for controlling check generation in embodiments that allow checks to be generated from an LEA instruction to check the memory location specified by the LEA instruction.

For checking data accesses from memory operand formats that do not have bits available to control the automatic generation of checks, those instructions may be preceded by explicit ChkTag instructions, or they may have checks automatically generated unconditionally. The compiler may adjust its instruction selection to minimize overall code size by preferring memory operand formats with bits available to control the automatic generation of checks. Other prefix types may be supported for controlling automatic check generation for memory operand formats lacking available bits.

If a narrow set of instruction types is defined to support automatically generating checks, compilers may be revised to generate code that makes more frequent use of those instruction types. For example, if MOV instructions support automatically generating checks, the compiler may reduce its use of memory operands in non-MOV instructions, instead generating MOV instructions to move values between registers and memory and using register-to-register variants of non-MOV instructions on those register values. Despite increasing instruction count, this may result in decreased code size. Similar optimizations may apply for register namespaces in terms of moving pointers between register namespaces to reduce overall code bloat.

In some implementations, new fused operations may be defined to perform a check followed by some other type of operation rather than using a prefix to modify (or prevent modification of) the operation of an existing instruction. For example, a “ChkTagAndMov” instruction could be defined that performs a ChkTag operation on the memory operand supplied to the instruction and then follows that with an operation equivalent to that of an existing move (MOV) instruction. In certain examples, if the check detects a memory safety violation, the instruction generates an exception and does not perform the MOV operation. Other types of operations could be fused with checks in this way, e.g., ADD, SUB, XOR, etc. To perform alignment checks on the supplied memory operands, the alignment could be derived from the operand size of the instruction. For example, certain ISAs (e.g., x86) may allow the operand size (e.g., 8, 16, 32, or 64 bits, etc.) to be determined based on a combination of the instruction opcode and prefixes.

### Metadata Access Control for Automatic Checks

In certain examples, a MovTag instruction has a distinct purpose in those examples that perform automatic checks. In certain examples, ordinary data accesses to metadata, e.g., tags or slot sizes, would be blocked, e.g., so only MovTag instructions could update tag metadata.

In certain examples, a corresponding MovSlotSz instruction is used to update the slot size. It could also implicitly invalidate any cached slot size configurations for the affected page on the current hardware thread.

Alternatively or additionally, MovSlotMetadata and MovPageMetadata instructions could be defined to allow updating specified metadata items. For example, those instructions could accept operands specifying an ID for a certain type of metadata to be updated, and the processor could map those metadata type IDs to metadata locations depending on the particular set of metadata types enabled for that page. Additional details and alternative examples are described below in the section on additional metadata types.

Alternatively, cryptographic protections can be applied to metadata clusters. This is an option for instrumentation-based examples as well. Each metadata cluster could be encrypted using a block cipher.
Even a 1-bit change would diffuse through the entire block
An authentication code could be added to each cluster for integrity

This could avoid the need for a MovTag ISA and for checking that data accesses do not access metadata. Instead, in certain examples, access to the key used to encrypt the clusters would need to be controlled.

In certain examples, this would add cryptographic overhead in allocator and check routines, although metadata could be stored in its unencrypted form in OLBs and sidecars.

A key locker (e.g., KeyLocker) could reduce cryptographic overheads, and it could help to limit access to the keys used to protect metadata clusters.

If a dedicated MovTag/MovSlotSz/MovSlotMetadata/MovPageMetadata instruction set (e.g., ISA) were defined, then the key to be used to protect metadata could be defined in an MSR.

### Hardening Global Variables

In certain examples, global variables could be placed in bucketed pages. In such examples, binary metadata and loader updates may support specifying bucketed slot sizes. In such examples, some memory may be used due to potentially loose fits between allocations and their containing slots and the potential for empty slots. In certain examples, compiler static analysis identifies some global variables that are (e.g., always) accessed in a safe manner and leave those in untagged pages to reduce memory and performance overheads.

### Stack Hardening

In certain examples, compiler passes perform static analysis on stack allocations and accesses to them, and that move unsafe stack allocations to heap, for example, LLVM SafeStack.

### Compatibility for Page-Sized Allocations

Some software, e.g., certain OS drivers, may assume that when it requests an allocation that is precisely one page in size, that exactly one page will be assigned. The software may only allocate sufficient resources to represent a single page. There may be other special cases, such as the self-mapping that certain OSes use to manage page tables. Even though it would be useful to enforce memory safety on accesses to such structures, it may be infeasible to indicate that those accesses are tagged and to perform the access to a large or huge page with adequate space for metadata, given the convoluted ways that PTEs are used in those cases.

To handle special cases that are incompatible with the metadata layout and other aspects discussed herein, in certain examples, the allocator can place those allocations into a region that is not marked as tagged or not mark the PTEs as tagged. For example, this may motivate defining a leaf-level PTE bit to enable tagging for a page so that OS kernel accesses to update page tables via the OS self-mapping do not enable tagging (e.g., since the non-leaf page tables that would be used as leaf page tables during the page table update would not have the tag bit set). Alternatively, an ambient control could be defined, e.g., an MSR bit, to globally enable or disable tagging, and that could be disabled during accesses that should not perform tag checks. However, there is overhead to update MSRs, and security coverage may diminish if an ambient control is used (e.g., by causing other accesses in that same code block to other data structures to not be checked).

In certain examples, if it is infeasible to indicate in the code requesting an allocation (e.g., via a new allocation routine parameter) whether the allocation is compatible with tagging or other metadata (e.g., due to the code being a legacy binary), there may be other indications that could be used instead. For example, the allocator could assume that allocations exactly one page in size are incompatible with tagging unless the code requesting the allocation explicitly opts into tagging.

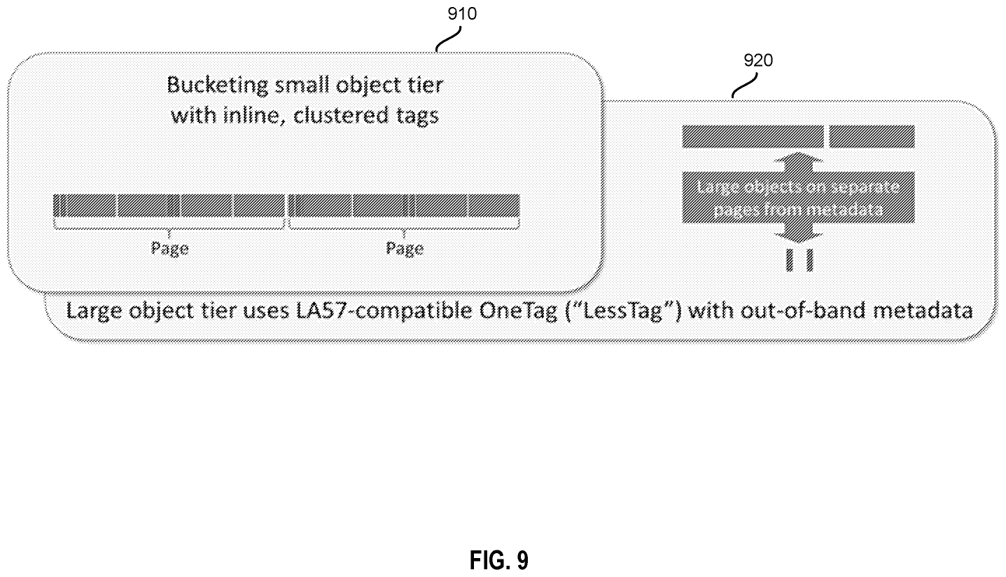

Another option for addressing the need to avoid disrupting the layouts of certain large allocations would be to provide different “tiers” depending on allocation size. An example of this is in FIG. 9. FIG. 9 illustrates bucketing smaller objects into a tier (e.g., tier 910) with inline clustered metadata (e.g., tags) and larger objects into a different tier (e.g., tier 920) without inline clustered metadata (e.g., tags) according to examples of the disclosure.

Other tiers are possible, such as full OneTag for large objects or traditional guard pages/redzones.

Other criteria could be used for selecting a tier besides allocation size. For example, it may be advantageous to use duplicated tags to protect stack allocations. The PTE could indicate what pages are for stacks versus other types of data.

Pointer bit(s) could select between different types of supported checks. Furthermore, even if multiple types of checks cannot be used in the same process, the processor could offer mode settings to select between different types of checks in different processes.

### Adding Other Types of Metadata Besides Tags

In certain examples, there are other types of metadata that are of interest, including some types that are meaningful on a per-allocation basis (like tags) and others that are meaningful when associated with an entire page (like slot size), e.g.:
Per-alloc:
   Reference counter for Chrome MiraclePtr
   Bitmap of fat pointer validity bits, e.g., for implementing CHERI
   Type
   Element size
      For example, to permit generating an exception or invoking a software error handler on dereference if the pointer is not an even multiple of the element size from the beginning of the slot. This is also more broadly applicable to arbitrary allocation layouts.
   Byte-granular size field indicating exact size of allocation within bucket
Per-page:
   PKEY value (for the Intel Page Protection Keys feature)
   Page type, e.g., whether the page contains a shadow stack.
   Hints for prefetchers, e.g., whether the page contains mostly sequentially vs. randomly accessed data

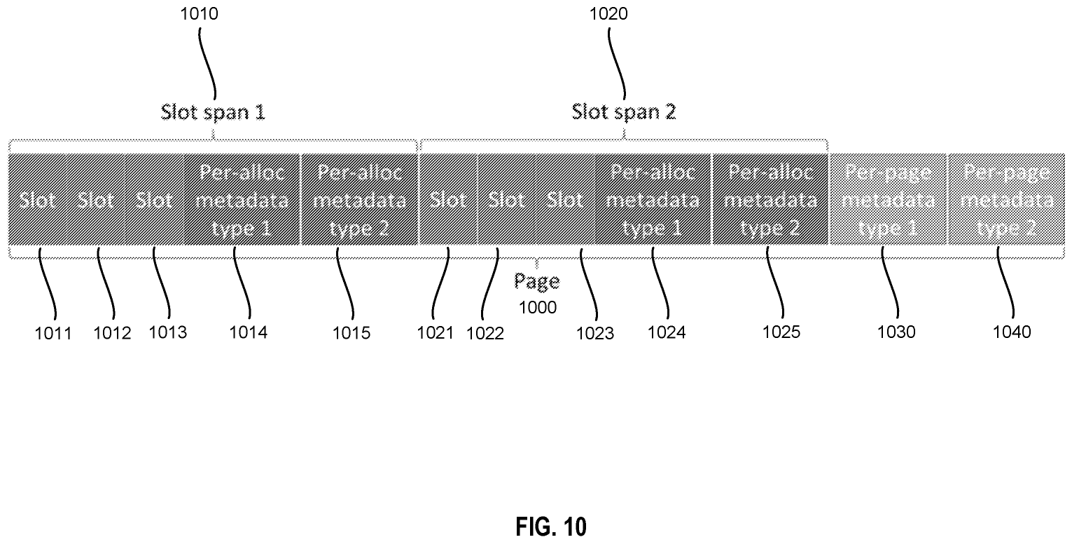

FIG. 10 illustrates multiple types of metadata (e.g., tags) positioned relative to data in a page (e.g., page 1000) according to examples of the disclosure. For example, a page (e.g., page 1000) may include a number of slots (e.g., slot 1011, slot 1012, slot 1013, slot 1021, slot 1022, slot 1023) grouped into clusters within slot spans (e.g., slot span 1010 including slot 1011, slot 1012, slot 1013, etc.; slot span 1020 including slot 1021, slot 1022, slot 1023, etc.), e.g., with each slot span also including an island of metadata (associated with its cluster). A page (e.g., page 1000) may also include a slot size (e.g., slot size 150) positioned at the end of each page to minimize disruption to data alignment, or it may be stored at some other position in each page.

An (e.g., each) island of metadata may include one or more fields for one or more different types of metadata (e.g., for one or more different types of metadata associated with the corresponding slots on a per-allocation basis, as described above). For example, a slot span may include a first field (e.g., field 1014, field 1024) for a first type of metadata (e.g., per-allocation metadata type 1) and a second field (e.g., field 1015, field 1025) for a second type of metadata (e.g., per-allocation metadata type 2).

A page (e.g., page 1000) may also include one or more fields for one or more different types of metadata (e.g., for one or more different types of metadata associated with the corresponding slots on a per-page basis, as described above) positioned at the end of each page to minimize disruption to data alignment, or it may be stored at some other position in each page. For example, a page may include a first field (e.g., field 1030) for a first type of metadata (e.g., per-page metadata type 1) and a second field (e.g., field 1040) for a second type of metadata (e.g., per-page metadata type 2).

Certain examples extend metadata clusters with software-defined metadata, e.g., add “SW metadata size” field (defining per-slot extra metadata size) at beginning of page in addition to “slot size” field.

Certain examples define new MovSlotMetadata instructions to access metadata associated with slots, e.g., avoiding software overhead of computing metadata locations using generic instructions.

Certain examples define new “LeaSlotMetadata” instruction to compute address of per-alloc metadata of a specified type (e.g., MiraclePtr reference counter) for the alloc containing a given pointer, e.g., use slot size cached in TLB to compute the metadata address without needing to reload the slot size from the page.

Certain examples implement software-based metadata checks comparable to corresponding hardware checks, e.g., to use the loaded private key (PKEY) value to index into a variable that indicates what permissions should be allowed for that page. Certain examples use (e.g., Asan-style) access instrumentation which may be accelerated (e.g., with RTCALL) and/or optimized by defining a new instruction analogous to ChkTag (e.g., ChkInPagePkey) to perform the checks, hardware automatically checking the in-page PKEY field for each access (e.g., reusing a private key such as WRPKRU of the Page Protection Keys (PPK) ISA, but obtain PKEY from a different source).

In certain examples, from a PTE bit standpoint, instead of directly indicating in the PTE what types of metadata are contained in each page, a PTE bit may be defined to indicate whether a page contains a per-page metadata descriptor such that the descriptor may be read during page walks to populate TLB with additional per-page metadata from the page itself.

In certain examples, these instructions could also be defined to support other metadata layouts (e.g., OneTag). Such layouts may be sparse, with gaps between tag and bounds metadata items. Those gaps could be used to store other types of metadata, such as the example types listed above. MovSlotMetadata/LeaSlotMetadata instructions could accept both an operand specifying an address in a data slot and an operand indicating the offset of the needed type of metadata from the beginning of the available metadata storage not used for the default tag and bounds. Alternatively, instead of two operands, the instruction could compute the offset within the data slot for a supplied memory address operand and transpose that to the same offset within the software-defined metadata region associated with that data slot. The MovSlotMetadata/LeaSlotMetadata instructions could then lookup the bounds for the allocation and determine the corresponding metadata space mapped to the entire range of the allocation. For example, they could use the same function that maps from the midpoint of the data slot to the midpoint of the metadata storage for the allocation but apply that function to the start and end locations of the entire data allocation to locate the corresponding endpoints in the metadata space. Those instructions could then add the specified metadata offset to the beginning of the metadata space for the appropriate allocation, accounting for the space consumed by the default metadata to skip over it. Alternatively, instead of specifying a metadata offset directly, software could specify a metadata type that is then mapped to an offset, e.g., through a table or register specifying different supported metadata types. If the specified metadata type is not supported, or if the directly or indirectly specified offset (plus the size of the metadata itself in the case of MovSlotMetadata) exceeds the available metadata space, then an exception can be generated.

### Optimizing Prefetches

In certain examples, prefetchers can check per-page metadata local to a memory controller to determine per-allocation slot boundaries. Prefetchers can then avoid crossing slot boundaries. If a validity bit array for fat pointers or other pointer types is one of the metadata types, an array-of-pointers prefetcher can use that to locate pointers to follow.

### Pointer Integrity

In certain examples, pointer integrity may be used to mitigate adversarial attempts to inject forged pointers or to corrupt existing pointers. Certain examples enforce integrity of a slice of address bits such that software is still able to modify sufficient address bits to point to any portion of a given object. In such example, instead of specifying a power-of-two slot size, which may not fit in limited available pointer bits in addition to other metadata such as a tag, other pointer integrity options are possible, such as:
Linear Frame Number (LFN) encryption.
   Encrypt linear frame number portion of address for tagged objects, e.g., [55:12] for small pages.
   Distinguish untagged vs. tagged object pointers using a pointer bit. Also encode page size in tagged pointers so that the processor knows how many pointer bits are encrypted. Do not encrypt untagged object pointers.
   This could be strengthened by specifying a subset of powers dictated by available pointer bits, e.g., 1K, 2K, 4K, 8K (i.e., unencrypted) encoded in two bits.
   In certain examples, a benefit of this option is that it is compatible with legacy pointer arithmetic.
Encrypt the whole pointer.
   Instrument pointer arithmetic to decrypt, modify, and re-encrypt pointer.
   May apply to both small and large objects.

Exemplary architectures, systems, etc. that the above may be used in are detailed below. Exemplary instruction formats that may cause any of the operations herein are detailed below.

At least some examples of the disclosed technologies can be described in view of the following examples:

Example 1. An apparatus comprising:
decoder circuitry to decode an instruction into a decoded instruction, the instruction having an opcode to indicate execution circuitry is to load and check linearly or physically indexed redundant or non-redundant metadata using instruction encodings that permit compilers to elide unneeded checks; and
the execution circuitry to execute the decoded instruction according to the opcode.
   Example 2. A method comprising:
decoding, by decoder circuitry, an instruction into a decoded instruction, the instruction having an opcode to indicate execution circuitry is to load and check linearly or physically indexed redundant or non-redundant metadata using instruction encodings that permit compilers to elide unneeded checks; and
executing, by the execution circuitry, the decoded instruction according to the opcode.

According to some examples, an apparatus includes decoder circuitry and execution circuitry. The decoder circuitry is to decode an instruction into a decoded instruction. The instruction has an opcode to indicate that the execution circuitry is to use metadata and instruction encodings to selectively perform a memory safety check. The execution circuitry is to execute the decoded instruction according to the opcode.

According to some examples, a method includes decoding, by decoder circuitry, an instruction into a decoded instruction, the instruction having an opcode to indicate execution circuitry is to use metadata and instruction encodings to selectively perform a memory safety check; and executing, by the execution circuitry, the decoded instruction according to the opcode.

According to some examples, a system includes a memory to store data and metadata; and a processor including decoder circuitry to decode an instruction into a decoded instruction, the instruction having an opcode to indicate execution circuitry is to use the metadata and instruction encodings to selectively perform a memory safety check; and the execution circuitry to execute the decoded instruction according to the opcode.

Any such examples may include any or any combination of the following aspects. The execution circuitry performing the memory safety check may include loading and checking the metadata. The metadata may be linearly indexed. The metadata may be physically indexed. The metadata may be redundant. The metadata may be non-redundant. Selectively performing the memory safety check may permit a compiler to elide unneeded checks. The metadata may include a tag per memory allocation slot. A plurality of memory allocation slots may be grouped into a first cluster and a plurality of tags may be grouped into a second cluster. The memory allocation slots grouped into the first cluster may be contiguous. The tags grouped into the second cluster may be contiguous. The metadata may include a plurality of contiguous tags corresponding to a plurality of contiguous memory allocation slots. Performing the memory safety check may include checking slot polarity.

According to some examples, an apparatus may include means for performing any function disclosed herein; an apparatus may include a data storage device that stores code that when executed by a hardware processor or controller causes the hardware processor or controller to perform any method or portion of a method disclosed herein; an apparatus, method, system etc. may be as described in the detailed description; a non-transitory machine-readable medium may store instructions that when executed by a machine causes the machine to perform any method or portion of a method disclosed herein. Embodiments may include any details, features, etc. or combinations of details, features, etc. described in this specification.

### Example Computer Architectures.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

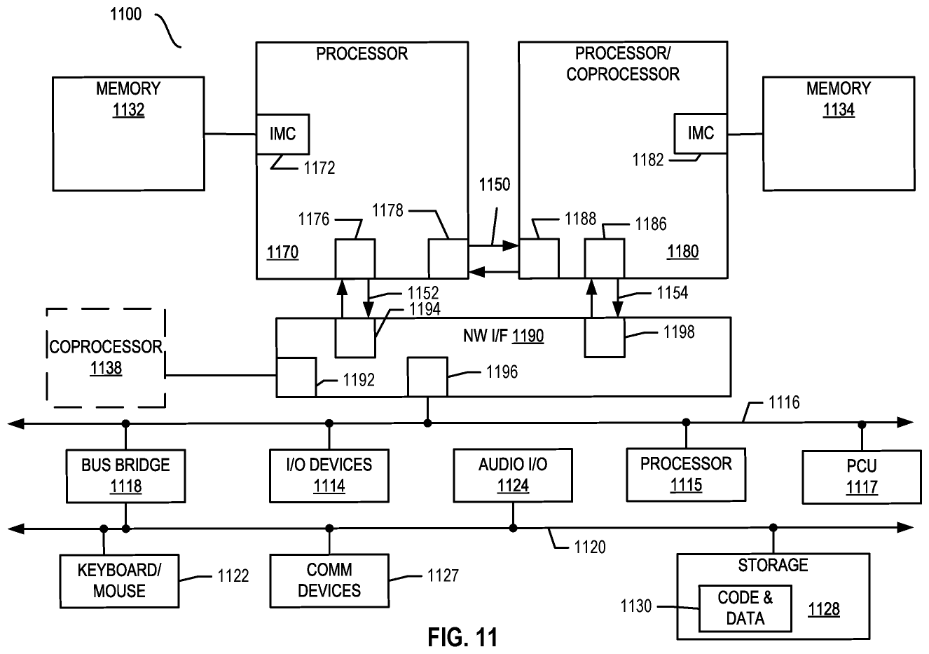

FIG. 11 illustrates an example computing system. Multiprocessor system 1100 is an interfaced system and includes a plurality of processors or cores including a first processor 1170 and a second processor 1180 coupled via an interface 1150 such as a point-to-point (P-P) interconnect, a fabric, and/or bus. In some examples, the first processor 1170 and the second processor 1180 are homogeneous. In some examples, the first processor 1170 and the second processor 1180 are heterogenous. Though the example system 1100 is shown to have two processors, the system may have three or more processors, or may be a single processor system. In some examples, the computing system is a system on a chip (SoC).

Processors 1170 and 1180 are shown including integrated memory controller (IMC) circuitry 1172 and 1182, respectively. Processor 1170 also includes interface circuits 1176 and 1178; similarly, second processor 1180 includes interface circuits 1186 and 1188. Processors 1170, 1180 may exchange information via the interface 1150 using interface circuits 1178, 1188. IMCs 1172 and 1182 couple the processors 1170, 1180 to respective memories, namely a memory 1132 and a memory 1134, which may be portions of main memory locally attached to the respective processors.

Processors 1170, 1180 may each exchange information with a network interface (NW I/F) 1190 via individual interfaces 1152, 1154 using interface circuits 1176, 1194, 1186, 1198. The network interface 1190 (e.g., one or more of an interconnect, bus, and/or fabric, and in some examples is a chipset) may optionally exchange information with a coprocessor 1138 via an interface circuit 1192. In some examples, the coprocessor 1138 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1170, 1180 or outside of both processors, yet connected with the processors via an interface such as P-P interconnect, such that either or both processors' local cache information may be stored in the shared cache if a processor is placed into a low power mode.

Network interface 1190 may be coupled to a first interface 1116 via interface circuit 1196. In some examples, first interface 1116 may be an interface such as a Peripheral Component Interconnect (PCI) interconnect, a PCI Express interconnect or another I/O interconnect. In some examples, first interface 1116 is coupled to a power control unit (PCU) 1117, which may include circuitry, software, and/or firmware to perform power management operations with regard to the processors 1170, 1180 and/or co-processor 1138. PCU 1117 provides control information to a voltage regulator (not shown) to cause the voltage regulator to generate the appropriate regulated voltage. PCU 1117 also provides control information to control the operating voltage generated. In various examples, PCU 1117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1117 is illustrated as being present as logic separate from the processor 1170 and/or processor 1180. In other cases, PCU 1117 may execute on a given one or more of cores (not shown) of processor 1170 or 1180. In some cases, PCU 1117 may be implemented as a microcontroller (dedicated or general-purpose) or other control logic configured to execute its own dedicated power management code, sometimes referred to as P-code. In yet other examples, power management operations to be performed by PCU 1117 may be implemented externally to a processor, such as by way of a separate power management integrated circuit (PMIC) or another component external to the processor. In yet other examples, power management operations to be performed by PCU 1117 may be implemented within BIOS or other system software.

Various I/O devices 1114 may be coupled to first interface 1116, along with a bus bridge 1118 which couples first interface 1116 to a second interface 1120. In some examples, one or more additional processor(s) 1115, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1116. In some examples, the second interface 1120 may be a low pin count (LPC) interface. Various devices may be coupled to second interface 1120 including, for example, a keyboard and/or mouse 1122, communication devices 1127 and storage circuitry 1128. Storage circuitry 1128 may be one or more non-transitory machine-readable storage media as described below, such as a disk drive or other mass storage device which may include instructions/code and data 1130 and may implement the storage 1103 in some examples. Further, an audio I/O 1124 may be coupled to second interface 1120. Note that other architectures than the point-to-point architecture described above are possible. For example, instead of the point-to-point architecture, a system such as multiprocessor system 1100 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

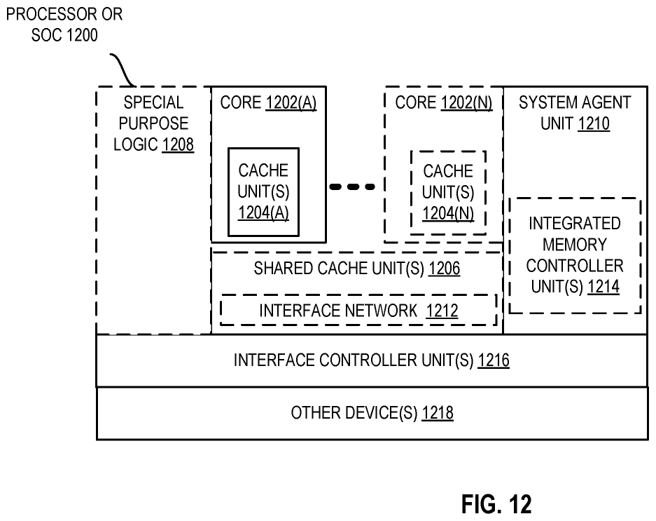

FIG. 12 illustrates a block diagram of an example processor and/or SoC 1200 that may have one or more cores and an integrated memory controller. The solid lined boxes illustrate a processor 1200 with a single core 1202(A), system agent unit circuitry 1210, and a set of one or more interface controller unit(s) circuitry 1216, while the optional addition of the dashed lined boxes illustrates an alternative processor 1200 with multiple cores 1202(A)-(N), a set of one or more integrated memory controller unit(s) circuitry 1214 in the system agent unit circuitry 1210, and special purpose logic 1208, as well as a set of one or more interface controller units circuitry 1216. Note that the processor 1200 may be one of the processors 1170 or 1180, or co-processor 1138 or 1115 of FIG. 11.

Thus, different implementations of the processor 1200 may include: 1) a CPU with the special purpose logic 1208 being integrated graphics and/or scientific (throughput) logic (which may include one or more cores, not shown), and the cores 1202(A)-(N) being one or more general purpose cores (e.g., general purpose in-order cores, general purpose out-of-order cores, or a combination of the two); 2) a coprocessor with the cores 1202(A)-(N) being a large number of special purpose cores intended primarily for graphics and/or scientific (throughput); and 3) a coprocessor with the cores 1202(A)-(N) being a large number of general purpose in-order cores. Thus, the processor 1200 may be a general-purpose processor, coprocessor, or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1200 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1204(A)-(N) within the cores 1202(A)-(N), a set of one or more shared cache unit(s) circuitry 1206, and external memory (not shown) coupled to the set of integrated memory controller unit(s) circuitry 1214. The set of one or more shared cache unit(s) circuitry 1206 may include one or more mid-level caches, such as level 2 (L2), level 3 (L3), level 4 (L4), or other levels of cache, such as a last level cache (LLC), and/or combinations thereof. While in some examples interface network circuitry 1212 (e.g., a ring interconnect) interfaces the special purpose logic 1208 (e.g., integrated graphics logic), the set of shared cache unit(s) circuitry 1206, and the system agent unit circuitry 1210, alternative examples use any number of well-known techniques for interfacing such units. In some examples, coherency is maintained between one or more of the shared cache unit(s) circuitry 1206 and cores 1202(A)-(N). In some examples, interface controller unit circuitry 1216 couples the cores 1202 to one or more other devices 1218 such as one or more I/O devices, storage, one or more communication devices (e.g., wireless networking, wired networking, etc.), etc.

In some examples, one or more of the cores 1202(A)-(N) are capable of multi-threading. The system agent unit circuitry 1210 includes those components coordinating and operating cores 1202(A)-(N). The system agent unit circuitry 1210 may include, for example, power control unit (PCU) circuitry and/or display unit circuitry (not shown). The PCU may be or may include logic and components needed for regulating the power state of the cores 1202(A)-(N) and/or the special purpose logic 1208 (e.g., integrated graphics logic). The display unit circuitry is for driving one or more externally connected displays.

The cores 1202(A)-(N) may be homogenous in terms of instruction set architecture (ISA). Alternatively, the cores 1202(A)-(N) may be heterogeneous in terms of ISA; that is, a subset of the cores 1202(A)-(N) may be capable of executing an ISA, while other cores may be capable of executing only a subset of that ISA or another ISA.

Example Core Architectures—In-order and out-of-order core block diagram.

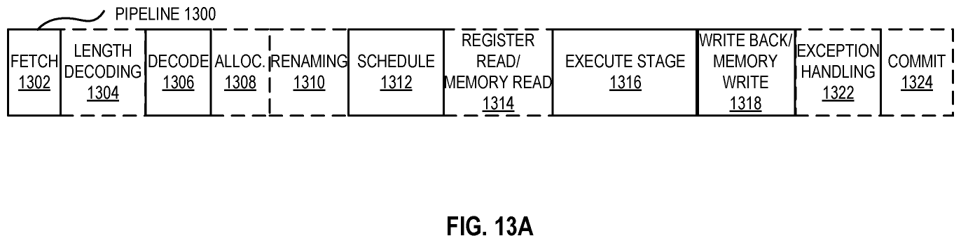

FIG. 13A is a block diagram illustrating both an example in-order pipeline and an example register renaming, out-of-order issue/execution pipeline according to examples. FIG. 13B is a block diagram illustrating both an example in-order architecture core and an example register renaming, out-of-order issue/execution architecture core to be included in a processor according to examples. The solid lined boxes in FIGS. 13A and 13B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 13A, a processor pipeline 1300 includes a fetch stage 1302, an optional length decoding stage 1304, a decode stage 1306, an optional allocation (Alloc) stage 1308, an optional renaming stage 1310, a schedule (also known as a dispatch or issue) stage 1312, an optional register read/memory read stage 1314, an execute stage 1316, a write back/memory write stage 1318, an optional exception handling stage 1322, and an optional commit stage 1324. One or more operations can be performed in each of these processor pipeline stages. For example, during the fetch stage 1302, one or more instructions are fetched from instruction memory, and during the decode stage 1306, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1306 and the register read/memory read stage 1314 may be combined into one pipeline stage. In one example, during the execute stage 1316, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 13B may implement the pipeline 1300 as follows: 1) the instruction fetch circuitry 1338 performs the fetch and length decoding stages 1302 and 1304; 2) the decode circuitry 1340 performs the decode stage 1306; 3) the rename/allocator unit circuitry 1352 performs the allocation stage 1308 and renaming stage 1310; 4) the scheduler(s) circuitry 1356 performs the schedule stage 1312; 5) the physical register file(s) circuitry 1358 and the memory unit circuitry 1370 perform the register read/memory read stage 1314; the execution cluster(s) 1360 perform the execute stage 1316; 6) the memory unit circuitry 1370 and the physical register file(s) circuitry 1358 perform the write back/memory write stage 1318; 7) various circuitry may be involved in the exception handling stage 1322; and 8) the retirement unit circuitry 1354 and the physical register file(s) circuitry 1358 perform the commit stage 1324.

FIG. 13B shows a processor core 1390 including front-end unit circuitry 1330 coupled to execution engine unit circuitry 1350, and both are coupled to memory unit circuitry 1370. The core 1390 may be a reduced instruction set architecture computing (RISC) core, a complex instruction set architecture computing (CISC) core, a very long instruction word (VLIW) core, or a hybrid or alternative core type. As yet another option, the core 1390 may be a special-purpose core, such as, for example, a network or communication core, compression engine, coprocessor core, general purpose computing graphics processing unit (GPGPU) core, graphics core, or the like.

The front-end unit circuitry 1330 may include branch prediction circuitry 1332 coupled to instruction cache circuitry 1334, which is coupled to an instruction translation lookaside buffer (TLB) 1336, which is coupled to instruction fetch circuitry 1338, which is coupled to decode circuitry 1340. In one example, the instruction cache circuitry 1334 is included in the memory unit circuitry 1370 rather than the front-end circuitry 1330. The decode circuitry 1340 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1340 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1340 may be implemented using various different mechanisms. Examples of suitable mechanisms include, but are not limited to, look-up tables, hardware implementations, programmable logic arrays (PLAs), microcode read only memories (ROMs), etc. In one example, the core 1390 includes a microcode ROM (not shown) or other medium that stores microcode for certain macroinstructions (e.g., in decode circuitry 1340 or otherwise within the front-end circuitry 1330). In one example, the decode circuitry 1340 includes a micro-operation (micro-op) or operation cache (not shown) to hold/cache decoded operations, micro-tags, or micro-operations generated during the decode or other stages of the processor pipeline 1300. The decode circuitry 1340 may be coupled to rename/allocator unit circuitry 1352 in the execution engine circuitry 1350.

The execution engine circuitry 1350 includes the rename/allocator unit circuitry 1352 coupled to retirement unit circuitry 1354 and a set of one or more scheduler(s) circuitry 1356. The scheduler(s) circuitry 1356 represents any number of different schedulers, including reservations stations, central instruction window, etc. In some examples, the scheduler(s) circuitry 1356 can include arithmetic logic unit (ALU) scheduler/scheduling circuitry, ALU queues, address generation unit (AGU) scheduler/scheduling circuitry, AGU queues, etc. The scheduler(s) circuitry 1356 is coupled to the physical register file(s) circuitry 1358. Each of the physical register file(s) circuitry 1358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1358 includes vector registers unit circuitry, writemask registers unit circuitry, and scalar register unit circuitry. These register units may provide architectural vector registers, vector mask registers, general-purpose registers, etc. The physical register file(s) circuitry 1358 is coupled to the retirement unit circuitry 1354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1354 and the physical register file(s) circuitry 1358 are coupled to the execution cluster(s) 1360. The execution cluster(s) 1360 includes a set of one or more execution unit(s) circuitry 1362 and a set of one or more memory access circuitry 1364. The execution unit(s) circuitry 1362 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1356, physical register file(s) circuitry 1358, and execution cluster(s) 1360 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1364). It should also be understood that where separate pipelines are used, one or more of these pipelines may be out-of-order issue/execution and the rest in-order.

In some examples, the execution engine unit circuitry 1350 may perform load store unit (LSU) address/data pipelining to an Advanced Microcontroller Bus (AMB) interface (not shown), and address phase and writeback, data phase load, store, and branches.

The set of memory access circuitry 1364 is coupled to the memory unit circuitry 1370, which includes data TLB circuitry 1372 coupled to data cache circuitry 1374 coupled to level 2 (L2) cache circuitry 1376. In one example, the memory access circuitry 1364 may include load unit circuitry, store address unit circuitry, and store data unit circuitry, each of which is coupled to the data TLB circuitry 1372 in the memory unit circuitry 1370. The instruction cache circuitry 1334 is further coupled to the level 2 (L2) cache circuitry 1376 in the memory unit circuitry 1370. In one example, the instruction cache 1334 and the data cache 1374 are combined into a single instruction and data cache (not shown) in L2 cache circuitry 1376, level 3 (L3) cache circuitry (not shown), and/or main memory. The L2 cache circuitry 1376 is coupled to one or more other levels of cache and eventually to a main memory.

The core 1390 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1390 includes logic to support a packed data instruction set architecture extension (e.g., AVX1, AVX2), thereby allowing the operations used by many multimedia applications to be performed using packed data.

### Example Execution Unit(s) Circuitry.

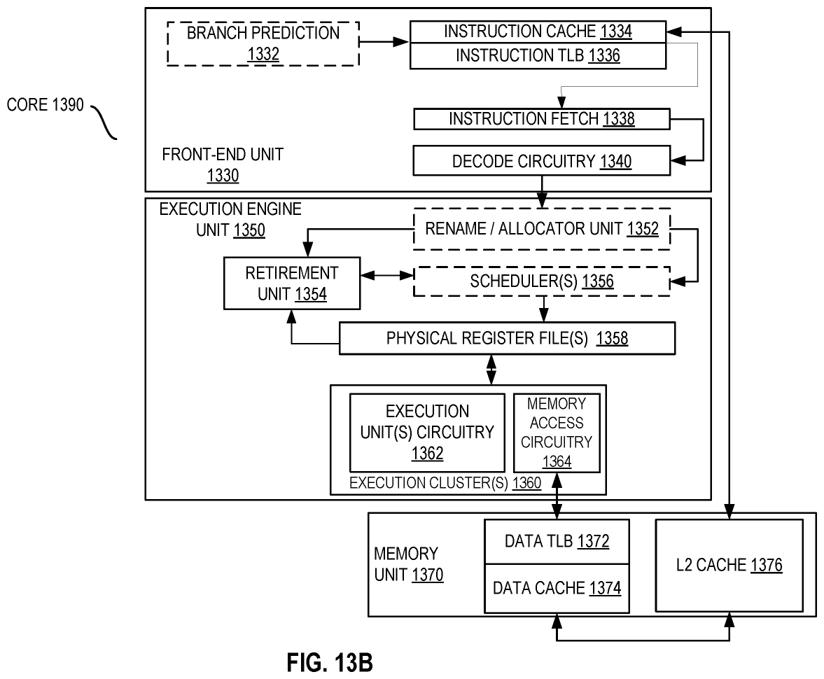

FIG. 14 illustrates examples of execution unit(s) circuitry, such as execution unit(s) circuitry 1362 of FIG. 13B. As illustrated, execution unit(s) circuitry 1362 may include one or more ALU circuits 1401, optional vector/single instruction multiple data (SIMD) circuits 1403, load/store circuits 1405, branch/jump circuits 1407, and/or Floating-point unit (FPU) circuits 1409. ALU circuits 1401 perform integer arithmetic and/or Boolean operations. Vector/SIMD circuits 1403 perform vector/SIMD operations on packed data (such as SIMD/vector registers). Load/store circuits 1405 execute load and store instructions to load data from memory into registers or store from registers to memory. Load/store circuits 1405 may also generate addresses. Branch/jump circuits 1407 cause a branch or jump to a memory address depending on the instruction. FPU circuits 1409 perform floating-point arithmetic. The width of the execution unit(s) circuitry 1362 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

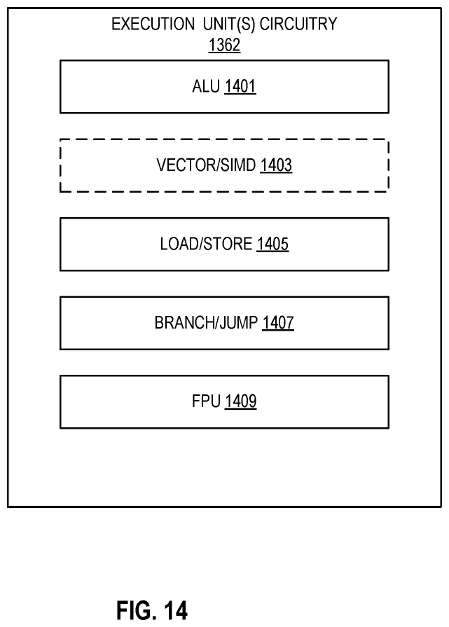

FIG. 15 is a block diagram of a register architecture 1500 according to some examples. As illustrated, the register architecture 1500 includes vector/SIMD registers 1510 that vary from 128-bit to 1,024 bits width. In some examples, the vector/SIMD registers 1510 are physically 512-bits and, depending upon the mapping, only some of the lower bits are used. For example, in some examples, the vector/SIMD registers 1510 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1500 includes writemask/predicate registers 1515. For example, in some examples, there are 8 writemask/predicate registers (sometimes called k0 through k7) that are each 16-bit, 32-bit, 64-bit, or 128-bit in size. Writemask/predicate registers 1515 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1515 corresponds to a data element position of the destination. In other examples, the writemask/predicate registers 1515 are scalable and consists of a set number of enable bits for a given vector element (e.g., 8 enable bits per 64-bit vector element).

The register architecture 1500 includes a plurality of general-purpose registers 1525. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1500 includes scalar floating-point (FP) register file 1545 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1540 (e.g., EFLAGS, RFLAGS, etc.) store status and control information for arithmetic, compare, and system operations. For example, the one or more flag registers 1540 may store condition code information such as carry, parity, auxiliary carry, zero, sign, and overflow. In some examples, the one or more flag registers 1540 are called program status and control registers.

Segment registers 1520 contain segment points for use in accessing memory. In some examples, these registers are referenced by the names CS, DS, SS, ES, FS, and GS.

Machine specific registers (MSRs) 1535 control and report on processor performance. Most MSRs 1535 handle system-related functions and are not accessible to an application program. Machine check registers 1560 consist of control, status, and error reporting MSRs that are used to detect and report on hardware errors.

One or more instruction pointer register(s) 1530 store an instruction pointer value. Control register(s) 1555 (e.g., CR0-CR4) determine the operating mode of a processor (e.g., processor 1170, 1180, 1138, 1115, and/or 1200) and the characteristics of a currently executing task. Debug registers 1550 control and allow for the monitoring of a processor or core's debugging operations.

Memory (mem) management registers 1565 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1500 may, for example, be used in register file/memory 1108, or physical register file(s) circuitry 1358.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

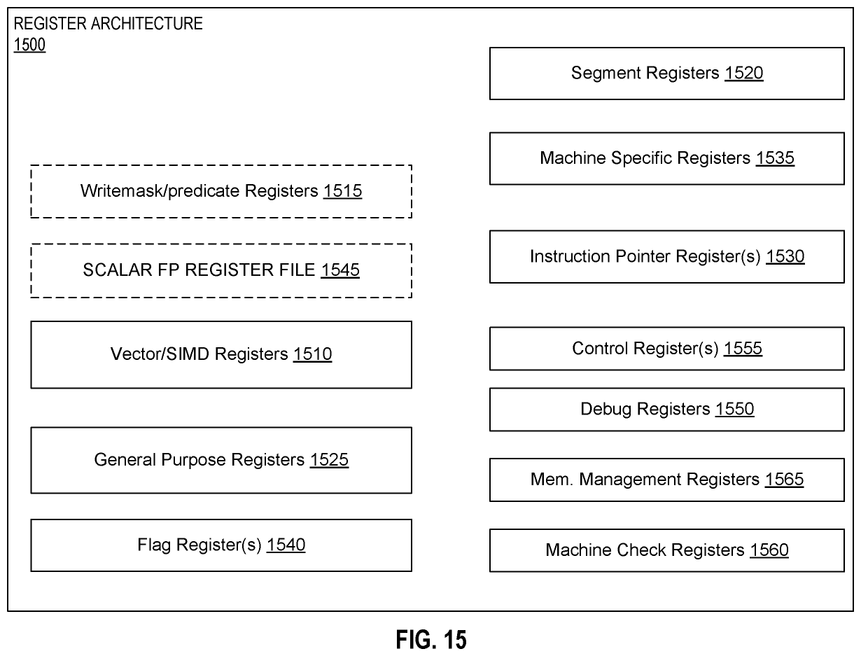

FIG. 16 illustrates examples of an instruction format. As illustrated, an instruction may include multiple components including, but not limited to, one or more fields for: one or more prefixes 1601, an opcode 1603, addressing information 1605 (e.g., register identifiers, memory addressing information, etc.), a displacement value 1607, and/or an immediate value 1609. Note that some instructions utilize some or all the fields of the format whereas others may only use the field for the opcode 1603. In some examples, the order illustrated is the order in which these fields are to be encoded, however, it should be appreciated that in other examples these fields may be encoded in a different order, combined, etc.

The prefix(es) field(s) 1601, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1603 is used to at least partially define the operation to be performed upon a decoding of the instruction. In some examples, a primary opcode encoded in the opcode field 1603 is one, two, or three bytes in length. In other examples, a primary opcode can be a different length. An additional 3-bit opcode field is sometimes encoded in another field.

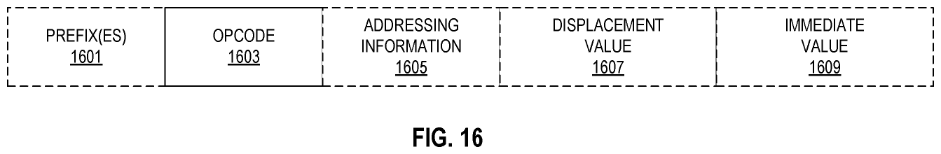

The addressing information field 1605 is used to address one or more operands of the instruction, such as a location in memory or one or more registers. FIG. 17 illustrates examples of the addressing information field 1605. In this illustration, an optional MOD R/M byte 1702 and an optional Scale, Index, Base (SIB) byte 1704 are shown. The MOD R/M byte 1702 and the SIB byte 1704 are used to encode up to two operands of an instruction, each of which is a direct register or effective memory address. Note that both of these fields are optional in that not all instructions include one or more of these fields. The MOD R/M byte 1702 includes a MOD field 1742, a register (reg) field 1744, and R/M field 1746.

The content of the MOD field 1742 distinguishes between memory access and non-memory access modes. In some examples, when the MOD field 1742 has a binary value of 11 (11b), a register-direct addressing mode is utilized, and otherwise a register-indirect addressing mode is used.

The register field 1744 may encode either the destination register operand or a source register operand or may encode an opcode extension and not be used to encode any instruction operand. The content of register field 1744, directly or through address generation, specifies the locations of a source or destination operand (either in a register or in memory). In some examples, the register field 1744 is supplemented with an additional bit from a prefix (e.g., prefix 1601) to allow for greater addressing.

The R/M field 1746 may be used to encode an instruction operand that references a memory address or may be used to encode either the destination register operand or a source register operand. Note the R/M field 1746 may be combined with the MOD field 1742 to dictate an addressing mode in some examples.

The SIB byte 1704 includes a scale field 1752, an index field 1754, and a base field 1756 to be used in the generation of an address. The scale field 1752 indicates a scaling factor. The index field 1754 specifies an index register to use. In some examples, the index field 1754 is supplemented with an additional bit from a prefix (e.g., prefix 1601) to allow for greater addressing. The base field 1756 specifies a base register to use. In some examples, the base field 1756 is supplemented with an additional bit from a prefix (e.g., prefix 1601) to allow for greater addressing. In practice, the content of the scale field 1752 allows for the scaling of the content of the index field 1754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1607 provides this value. Additionally, in some examples, a displacement factor usage is encoded in the MOD field of the addressing information field 1605 that indicates a compressed displacement scheme for which a displacement value is calculated and stored in the displacement field 1607.

In some examples, the immediate value field 1609 specifies an immediate value for the instruction. An immediate value may be encoded as a 1-byte value, a 2-byte value, a 4-byte value, etc.

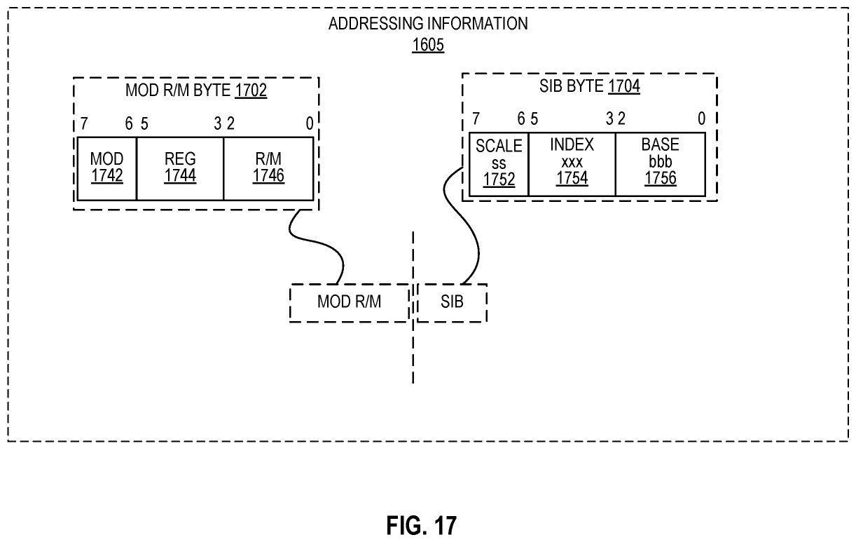

FIG. 18 illustrates examples of a first prefix 1601(A). In some examples, the first prefix 1601(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1601(A) may specify up to three registers using 3-bit fields depending on the format: 1) using the reg field 1744 and the R/M field 1746 of the MOD R/M byte 1702; 2) using the MOD R/M byte 1702 with the SIB byte 1704 including using the reg field 1744 and the base field 1756 and index field 1754; or 3) using the register field of an opcode.

In the first prefix 1601(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1744 and MOD R/M R/M field 1746 alone can each only address 8 registers.

In the first prefix 1601(A), bit position 2 (R) may be an extension of the MOD R/M reg field 1744 and may be used to modify the MOD R/M reg field 1744 when that field encodes a general-purpose register, a 64-bit packed data register (e.g., an SSE register), or a control or debug register. R is ignored when MOD R/M byte 1702 specifies other registers or defines an extended opcode.

Bit position 1 (X) may modify the SIB byte index field 1754.

Bit position 0 (B) may modify the base in the MOD R/M R/M field 1746 or the SIB byte base field 1756; or it may modify the opcode register field used for accessing general purpose registers (e.g., general purpose registers 1525).

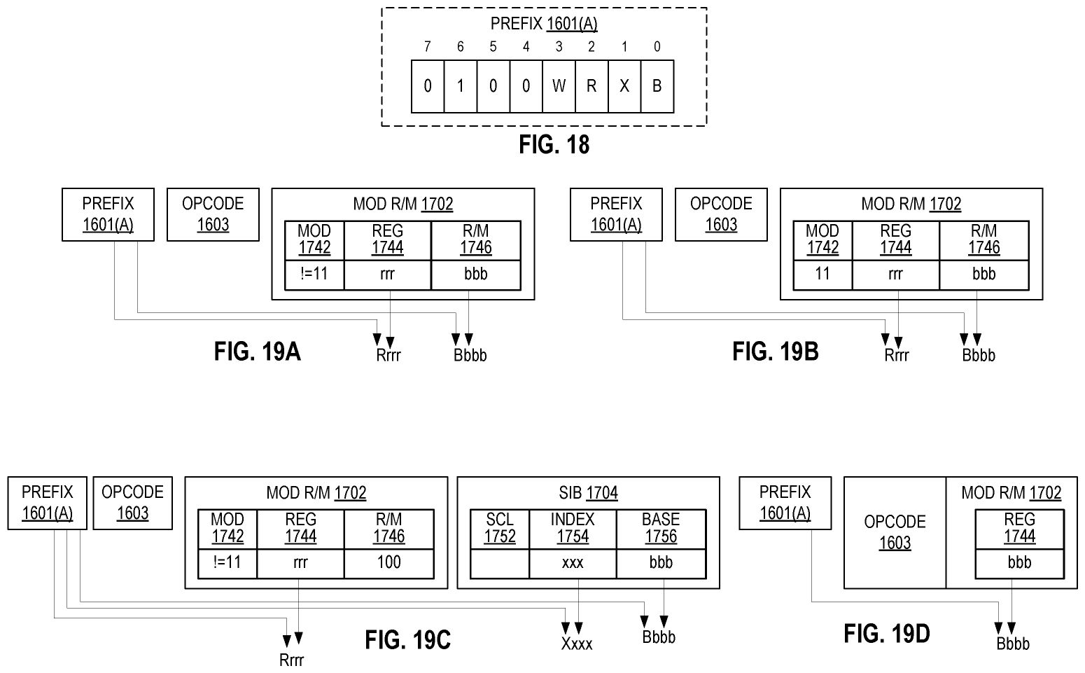

FIGS. 19A-19D illustrate examples of how the R, X, and B fields of the first prefix 1601(A) are used. FIG. 19A illustrates R and B from the first prefix 1601(A) being used to extend the reg field 1744 and R/M field 1746 of the MOD R/M byte 1702 when the SIB byte 1704 is not used for memory addressing. FIG. 19B illustrates R and B from the first prefix 1601(A) being used to extend the reg field 1744 and R/M field 1746 of the MOD R/M byte 1702 when the SIB byte 1704 is not used (register-register addressing). FIG. 19C illustrates R, X, and B from the first prefix 1601(A) being used to extend the reg field 1744 of the MOD R/M byte 1702 and the index field 1754 and base field 1756 when the SIB byte 1704 being used for memory addressing. FIG. 19D illustrates B from the first prefix 1601(A) being used to extend the reg field 1744 of the MOD R/M byte 1702 when a register is encoded in the opcode 1603.

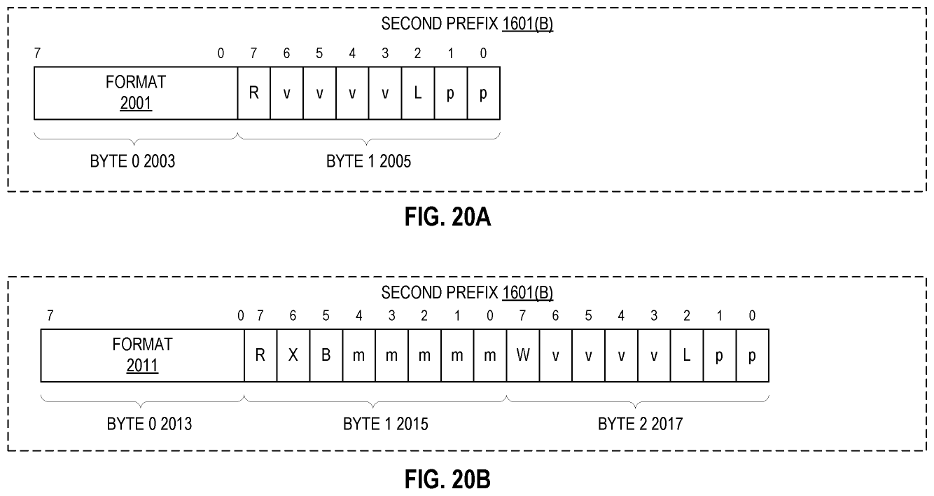

FIGS. 20A and 20B illustrate examples of a second prefix 1601(B). In some examples, the second prefix 1601(B) is an example of a VEX prefix. The second prefix 1601(B) encoding allows instructions to have more than two operands, and allows SIMD vector registers (e.g., vector/SIMD registers 1510) to be longer than 64-bits (e.g., 128-bit and 256-bit). The use of the second prefix 1601(B) provides for three-operand (or more) syntax. For example, previous two-operand instructions performed operations such as A=A+B, which overwrites a source operand. The use of the second prefix 1601(B) enables operands to perform nondestructive operations such as A=B+C.

In some examples, the second prefix 1601(B) comes in two forms—a two-byte form and a three-byte form. The two-byte second prefix 1601(B) is used mainly for 128-bit, scalar, and some 256-bit instructions; while the three-byte second prefix 1601(B) provides a compact replacement of the first prefix 1601(A) and 3-byte opcode instructions.

FIG. 20A illustrates examples of a two-byte form of the second prefix 1601(B). In one example, a format field 2001 (byte 0 2003) contains the value C5H. In one example, byte 1 2005 includes an “R” value in bit[7]. This value is the complement of the “R” value of the first prefix 1601(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (is complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the MOD R/M R/M field 1746 to encode the instruction operand that references a memory address or encode either the destination register operand or a source register operand.

Instructions that use this prefix may use the MOD R/M reg field 1744 to encode either the destination register operand or a source register operand, or to be treated as an opcode extension and not used to encode any instruction operand.

For instruction syntax that supports four operands, vvvv, the MOD R/M R/M field 1746 and the MOD R/M reg field 1744 encode three of the four operands. Bits[7:4] of the immediate value field 1609 are then used to encode the third source register operand.

FIG. 20B illustrates examples of a three-byte form of the second prefix 1601(B). In one example, a format field 2011 (byte 0 2013) contains the value C4H. Byte 1 2015 includes in bits[7:5] “R,” “X,” and “B” which are the complements of the same values of the first prefix 1601(A). Bits[4:0] of byte 1 2015 (shown as mmmmm) include content to encode, as needed, one or more implied leading opcode bytes. For example, 00001 implies a 0FH leading opcode, 00010 implies a 0F38H leading opcode, 00011 implies a 0F3AH leading opcode, etc.

Bit[7] of byte 2 2017 is used similar to W of the first prefix 1601(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (is complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the MOD R/M R/M field 1746 to encode the instruction operand that references a memory address or encode either the destination register operand or a source register operand.

Instructions that use this prefix may use the MOD R/M reg field 1744 to encode either the destination register operand or a source register operand, or to be treated as an opcode extension and not used to encode any instruction operand.

For instruction syntax that supports four operands, vvvv, the MOD R/M R/M field 1746, and the MOD R/M reg field 1744 encode three of the four operands. Bits[7:4] of the immediate value field 1609 are then used to encode the third source register operand.

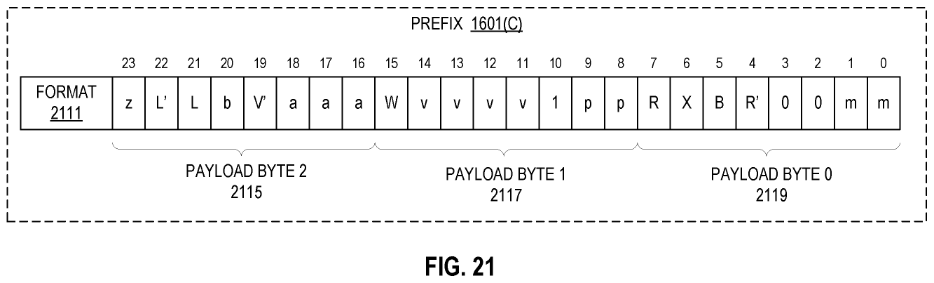

FIG. 21 illustrates examples of a third prefix 1601(C). In some examples, the third prefix 1601(C) is an example of an EVEX prefix. The third prefix 1601(C) is a four-byte prefix.

The third prefix 1601(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 15) or predication utilize this prefix. Opmask register allows for conditional processing or selection control. Opmask instructions, whose source/destination operands are opmask registers and treat the content of an opmask register as a single value, are encoded using the second prefix 1601(B).

The third prefix 1601(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1601(C) is a format field 2111 that has a value, in one example, of 62H. Subsequent bytes are referred to as payload bytes 2115-2119 and collectively form a 24-bit value of P[23:0] providing specific capability in the form of one or more fields (detailed herein).

In some examples, P[1:0] of payload byte 2119 are identical to the low two mm bits. P[3:2] are reserved in some examples. Bit P[4] (R′) allows access to the high 16 vector register set when combined with P[7] and the MOD R/M reg field 1744. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1744 and MOD R/M R/M field 1746. P[9:8]provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (Is complement) form and valid for instructions with 2 or more source operands; 2) encode the destination register operand, specified in is complement form for certain vector shifts; or 3) not encode any operand, the field is reserved and should contain a certain value, such as 1111b.

P[15] is similar to W of the first prefix 1601(A) and second prefix 1611(B) and may serve as an opcode extension bit or operand size promotion.

P[18:16] specify the index of a register in the opmask (writemask) registers (e.g., writemask/predicate registers 1515). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20]encodes multiple functionalities, which differ across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1601(C) are detailed in the following tables.

TABLE 1
32-Register Support in 64-bit Mode

| | | | | REG. | |
|---|---|---|---|---|---|
| | 4 | 3 | [2:0] | TYPE | COMMON USAGES |
| REG | R′ | R | MOD R/M | GPR, | Destination or Source |
| | | | reg | Vector | |
| VVVV | V′ | vvvv | | GPR, | 2nd Source or Destination |
| | | | | Vector | |
| RM | X | B | MOD R/M | GPR, | 1st Source or Destination |
| | | | R/M | Vector | |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

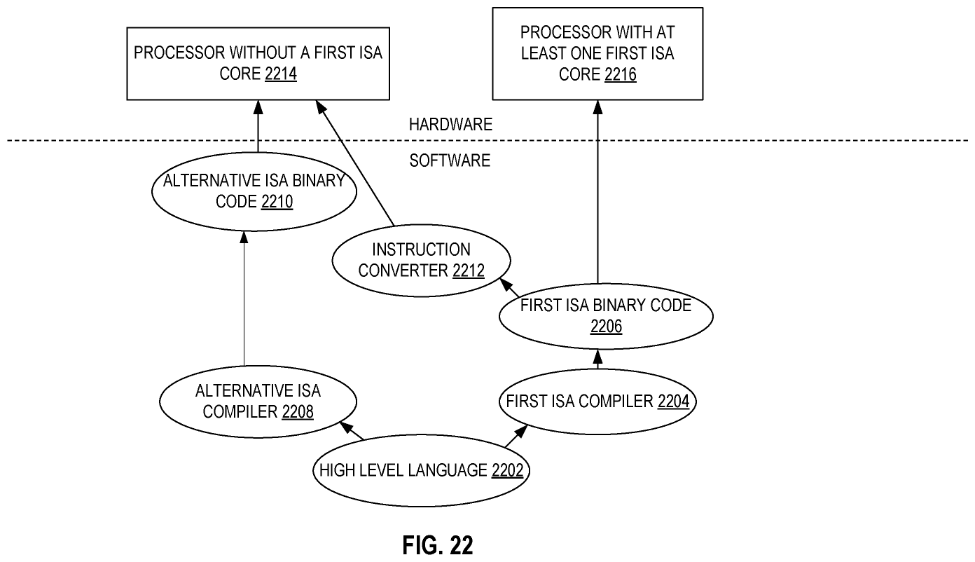

FIG. 22 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 22 shows a program in a high-level language 2202 may be compiled using a first ISA compiler 2204 to generate first ISA binary code 2206 that may be natively executed by a processor with at least one first ISA core 2216. The processor with at least one first ISA core 2216 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2204 represents a compiler that is operable to generate first ISA binary code 2206 (e.g., object code) that can, with or without additional linkage processing, be executed on the processor with at least one first ISA core 2216. Similarly, FIG. 22 shows the program in the high-level language 2202 may be compiled using an alternative ISA compiler 2208 to generate alternative ISA binary code 2210 that may be natively executed by a processor without a first ISA core 2214. The instruction converter 2212 is used to convert the first ISA binary code 2206 into code that may be natively executed by the processor without a first ISA core 2214. This converted code is not necessarily to be the same as the alternative ISA binary code 2210; however, the converted code will accomplish the general operation and be made up of instructions from the alternative ISA. Thus, the instruction converter 2212 represents software, firmware, hardware, or a combination thereof that, through emulation, simulation, or any other process, allows a processor or other electronic device that does not have a first ISA processor or core to execute the first ISA binary code 2206.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
decoder circuitry to decode an instruction into a decoded instruction, the instruction having an opcode to indicate execution circuitry is to use metadata and instruction encodings to selectively perform a memory safety check; and
the execution circuitry to execute the decoded instruction according to the opcode.

2. The apparatus of claim 1, wherein the execution circuitry performing the memory safety check includes loading and checking the metadata.

3. The apparatus of claim 1, wherein the metadata is linearly indexed.

4. The apparatus of claim 1, wherein the metadata is physically indexed.

5. The apparatus of claim 1, wherein the metadata is redundant.

6. The apparatus of claim 1, wherein the metadata is non-redundant.

7. The apparatus of claim 1, wherein selectively performing the memory safety check is to permit a compiler to elide unneeded checks.

8. The apparatus of claim 1, wherein the metadata is to include a tag per memory allocation slot.

9. The apparatus of claim 8, wherein a plurality of memory allocation slots are to be grouped into a first cluster and a plurality of tags are to be grouped into a second cluster.

10. The apparatus of claim 9, wherein memory allocation slots grouped into the first cluster are to be contiguous.

11. The apparatus of claim 10, wherein tags grouped into the second cluster are to be contiguous.

12. The apparatus of claim 8, wherein performing the memory safety check is to include checking slot polarity.

13. A method comprising:
decoding, by decoder circuitry, an instruction into a decoded instruction, the instruction having an opcode to indicate execution circuitry is to use metadata and instruction encodings to selectively perform a memory safety check; and
executing, by the execution circuitry, the decoded instruction according to the opcode.

14. The method of claim 13, wherein performing the memory safety check includes loading and checking the metadata.

15. The method of claim 13, wherein the metadata is linearly indexed or physically indexed.

16. The method of claim 13, wherein selectively performing the memory safety check permits a compiler to elide unneeded checks.

17. The method of claim 13, wherein the metadata is to include a plurality of contiguous tags corresponding to a plurality of contiguous memory allocation slots.

18. The method of claim 17, wherein performing the memory safety check is to include checking slot polarity.

19. A system comprising:
a memory to store data and metadata; and
a processor including:
decoder circuitry to decode an instruction into a decoded instruction, the instruction having an opcode to indicate execution circuitry is to use the metadata and instruction encodings to selectively perform a memory safety check; and
the execution circuitry to execute the decoded instruction according to the opcode.

20. The system of claim 19, wherein the metadata is to include a plurality of contiguous tags corresponding to a plurality of contiguous memory allocation slots for data.
